(19) United States
(12) Patent Application Publication
(10) Pub. No.: US 2022/0067513 A1
(43) Pub. Date: Mar. 3, 2022

(54) EFFICIENT SOFTMAX COMPUTATION

(71) Applicant: NVIDIA Corp., Santa Clara, CA (US)

(72) Inventors: Jacob Robert Stevens, Boston, MA (US); Rangharajan Venkatesan, Sunnyvale, CA (US); Steve Haihang Dai, Union City, CA (US); Brucek Khailany, Austin, TX (US)

(73) Assignee: NVIDIA Corp., Santa Clara, CA (US)

(21) Appl. No.: 17/112,795

(22) Filed: Dec. 4, 2020

Related U.S. Application Data
(60) Provisional application No. 63/071,968, filed on Aug. 28, 2020.

(51) Int. Cl. G06N 3/08; G06N 3/063; G06F 7/552; G06F 7/50

(52) U.S. Cl. CPC G06N 3/08; G06F 7/50; G06F 7/552; G06N 3/063

(57) ABSTRACT

Solutions improving efficiency of Softmax computation applied for efficient deep learning inference in transformers and other neural networks. The solutions utilize a reduced-precision implementation of various operations in Softmax, replacing e^{x} with 2^{x} to reduce instruction overhead associated with computing e^{x}, and replacing floating point max computation with integer max computation. Further described is a scalable implementation that decomposes Softmax into UnNormalized Softmax and Normalization operations.

### CROSS REFERENCE TO RELATED APPLICATIONS

This application claims priority and benefit under 35 U.S.C. 119(e) to U.S. Application Ser. No. 62/817,413, filed on Mar. 12, 2019, the contents of which are incorporated herein by reference in their entirety.

### BACKGROUND

A Softmax computation is commonly used in various types of neural networks and deep learning applications. Examples of neural networks utilizing Softmax are recurrent neural networks, convolutional neural networks, and transformer neural networks.

Conventional computation of Softmax has drawbacks including low memory utilization and being computationally expensive in some aspects. Thus neural network and deep learning applications may benefit from more efficient computation of Softmax.

Transformer neural networks in particular have shown promising results for conversational artificial intelligence (AI) applications. Transformer networks use attention mechanisms that utilize Softmax in both encoder and decoder stages, and may particularly benefit from more efficient Softmax computation.

Deep neural networks (DNNs) are a class of neural network that has emerged as a key approach for solving complex problems across various technical fields, especially those involving deep machine learning. Applications of DNNs have diverse performance, accuracy, and power requirements depending on the implementation. Building dedicated DNNs for the requirements of particular implementations may be cost prohibitive due to high design complexity and manufacturing challenges. Deep neural networks, which also tend to utilize Softmax computations a great deal, may thus also benefit from more efficient Softmax computation.

In some aspects, a system includes one or more processors. The system includes logic that when applied to the one or more processors computes an unnormalized Softmax vector from an input vector by raising elements of the input vector to powers of two and computing an integer vector maximum of the input vector. The system further includes logic that when applied to the one or more processors transforms the unnormalized Softmax vector into a normalized Softmax vector.

In other aspects, an artificial neural network includes one or more feed-forward layers, and one or more Softmax layers coupled to the one or more feed-forward layers. The artificial neural network includes at least one of the Softmax layers configured to compute an unnormalized Softmax vector from an input vector by raising elements of the input vector to powers of two and computing an integer vector maximum of the input vector.

In yet other aspects, a transformer artificial neural network includes a self-attention layer and an encoder-decoder attention layer. Each of the self-attention layer and the encoder-decoder attention layer include a Softmax layer configured to generate an unnormalized Softmax vector from an input vector by raising elements of the input vector to powers of two and computing an integer vector maximum of the input vector.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts an exemplary system 100 utilizing artificial neural networks.

FIG. 2 depicts a deep learning system 202 in accordance with one embodiment.

FIG. 3 depicts a transformer neural network 302 in accordance with one embodiment.

FIG. 4 depicts an encoder 402 in accordance with one embodiment.

FIG. 5 depicts a decoder 502 in accordance with one embodiment.

FIG. 6 depicts an attention layer 602 in accordance with one embodiment.

FIG. 7A-FIG. 7C depict a Softmax algorithm 700 in accordance with one embodiment.

FIG. 8A-FIG. 8D depict Softmax computational logic 800 in one embodiment.

FIG. 9 depicts a distributed computing system 900 for Softmax computation in accordance with one embodiment.

FIG. 10 depicts a multi-die package 1012 in accordance with one embodiment.

FIG. 11 depicts a neural network processor 1100 implemented on a single chip in accordance with one embodiment.

FIG. 12 depicts a local processing element 1200 in accordance with one embodiment.

FIG. 13 depicts a local processing element 1300 in more detail, in accordance with one embodiment.

FIG. 14 depicts details of a post-processor 1212 in accordance with one embodiment.

FIG. 15 depicts a global processing element 1522 in accordance with one embodiment.

FIG. 16 depicts a parallel processing unit 2008b in accordance with one embodiment.

FIG. 17 depicts a general processing cluster 1700 in accordance with one embodiment.

FIG. 18 depicts a memory partition unit 1800 in accordance with one embodiment.

FIG. 19 depicts a streaming multiprocessor 1900 in accordance with one embodiment.

FIG. 20 depicts a processing system 2000 in accordance with one embodiment.

FIG. 21 depicts an exemplary processing system 2100 in accordance with another embodiment.

FIG. 22 depicts a graphics processing pipeline 2200 in accordance with one embodiment.

### DETAILED DESCRIPTION

In many deep learning applications, it is common to perform inference on a trained model with less precise data representations to increase performance (improve throughput or latency per inference) and reduce computational energy expended per inference. These models may be applied within tensor cores on programmable graphics processing units (GPUs) or in dedicated deep learning accelerators. Some solutions focus on improving the performance of neural network layers by implementing such layers as batched matrix-multiply operations in GPUs. “Neural network” refers to an algorithm or computational system based on a collection of connected units or nodes called artificial neurons, which loosely model the neurons in a biological system. Each connection between neurons, like the synapses in a biological brain, can transmit a signal (an activation) from one artificial neuron to another. An artificial neuron that receives a signal (the input activation) can process it and then signal additional artificial neurons (the output activation) connected to it. “Input activation” refers to an activation received by a neuron in a neural network. “Output activation” refers to an activation output by a neuron in a neural network. An output activation is typically computed based on the input activations to the neuron and the weights applied to the input activations. “Weights” refers to values with which activations are multiplied to increase or decrease the impact of the activation values in an activation function. “Activations” refers to the output values of neurons in a neural network, computed based at least in part on weights input to the neuron and an activation function of the neuron. Activations are also called ‘activation values’.

The core matrix-multiply computations have continued to improve in computational performance with subsequent generations of GPU hardware. Other aspects of deep learning applications have thus become bottlenecks. For example, in many conversational artificial intelligence workloads, such as transformer-based neural networks, Softmax computations may emerge as a bottleneck.

Conversational AI implementations utilizing transformer neural networks may be particularly impacted by poor Softmax performance. At a high level, transformer neural network structures comprise an encoding component, a decoding component, and connections between these components. The encoding component may comprise a stack of multiple encoding stages and the decoding component may comprise a stack of multiple decoding stages, typically of the same number as there are encoding stages. The encoding stages (“encoders” for short) are neural networks and typically may be identical in structure to one another, except they may acquire differences during training (e.g., be trained to have different weights from one another). Likewise the decoding stages (“decoders” for short) may typically all have the same structure except for differences acquired in training. The encoders and decoders may comprise “layers” that perform operations on vector inputs to generate vector or scalar outputs. These vectors may be multidimensional (generally NxMx . . . P, N, M, . . . P>1) and nested, and are commonly referred to as tensors.

Conventional Softmax computation typically involves the following operations: (i) compute a maximum value in an input vector, (ii) apply an exponent to a floating-point or fixed-point number, (iii) perform a summation of exponent values, and (iv) perform a division of the exponent value by the sum. The formula for a conventional Softmax operation is

$$σ ( {x}_{j} ) = \frac{{e}^{{x}_{j}}}{{\sum }_{i} {e}^{{x}_{i}}}$$

### Conventional Softmax Equation

A computing algorithm for conventional Softmax is:

1: m₀ ← −∞
2: for k ← 1, V do
3: mₖ ← max(mk-1, xₖ)
4: end for
5: d₀ ← 0
6: for j ← 1, V do
7: dⱼ ← dⱼ₋₁ + e^{x}ⱼ^{-m}_{V}
8: end for
9: for i ← 1, V do
10: ${y}_{i} ← \frac{e \text{?}}{{d}_{V}}$
11: end for

$\text{?} \text{indicates text missing or illegible when filed}$

### Conventional Softmax Algorithm

This algorithm involves multiple accesses to memory and exhibits low operand reuse, sometimes resulting in poor performance. The loop 2:-4: over the vector V (to find the maximum valued member mᵥ of the vector V) involves a vector read from memory; the loop 6:-8: to compute the sum of exponentials involves another; and the loop 9:-11: to normalize V involves yet another.

Implementing the exponent and reciprocal functions in hardware (for speed) may incur high design overhead (circuit area and/or power consumption). For example, exponent and reciprocal functions may be performed in the special function unit (SFU) of a GPU configured with look-up tables (LUTs) with 32-bit floating-point precision. The high circuit area overhead of these components may make replication of SFU units to achieve high throughput prohibitively expensive.

Disclosed herein are embodiments that improve the efficiency of Softmax computation. These solutions may be utilized to implement fast and efficient deep learning inference in transformers and other neural networks. The disclosed Softmax computation comprises reduced precision implementation of various operations, replacing e^{x} with 2^{x} to reduce instruction overhead associated with computing e^{x}, and replacing floating point max computation of vector elements with an integer max computation. One scalable implementation decomposes Softmax into separate UnNormalized Softmax and Normalization operations.

The disclosed approaches compute Softmax by formulating a vector of 2^{x} valued elements. The expression “vector of 2^{x} valued elements” refers to a vector of elements each raised to a power of two, where the exponent of the power of two is computed utilizing an input value x from an input vector of elements. It should be understood that the actual exponent of the power of two, when referring to the “vector of 2^{x} valued elements”, may not actually be x, but rather a value derived from x (e.g., x-xₘₐₓ), where xₘₐₓ is a running computed maximum value of the input vector elements.

Also described herein are embodiments of an efficient, tiled DNN processor that utilizes a scalable design. These embodiments may benefit from the disclosed improvements to Softmax computation. The disclosed embodiments comprise beneficial features including: 1) a fully distributed, tile-based architecture, 2) flexible and efficient weight and activation tiling at the processing element (PE) level, chip-level, and in some embodiments, package-level, improving data locality and reducing communication cost, and 3) multi-level dataflows, improving the data reuse and energy efficiency.

The DNN processor embodiments utilize a data path designed to account for the low computation-to-memory ratio of neural network layers. The data path includes, in some implementations, both local and global processing elements. Each local processing element comprises logic to perform localized multiply-accumulation of weights and input activations, and post-processing such as ReLu, MaxPool, Softmax, etc. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

Memory buffers in the form of collectors and register files may be disposed into the data path within and/or between processing elements. “Buffer” refers to a memory storing values that are inputs to or results from a calculation. “Collector” refers to a buffer disposed between another buffer and the input or output of a data processor, such as a multiply-accumulate unit. “Multiply-accumulate unit” refers to a data processing circuit that carries out multiply-accumulate operations, which involve computing the product of two numbers and adding that product to an accumulator. Multiply-accumulate units may be referred to herein by their acronym, MAC or MAC unit. A multiply-accumulate unit carries out computations of the form a<-a+(b*c). A vector multiply-accumulate unit computes the product of two vectors using an array of multipliers, then performs a reduction operation by adding all the outputs of multipliers to produce a partial sum, which is then added to an accumulator. “Partial sum” refers to an intermediate multiply-accumulate result in a dot-product-accumulate calculation. “Dot-product-accumulate” refers to the computation of a dot product. A dot product is the sum of the products of the corresponding entries of the two sequences (vectors) of numbers. Dot products are efficiently computed using vector multiply-accumulate units.

The DNN processor embodiments provide a multi-level memory and computation hierarchy that exploits both weight and output activation locality to improve the energy efficiency of neural network execution. Conventional neural network accelerator designs only leverage the reuse opportunity of the innermost execution level (e.g., loop), whereas the disclosed architecture provides a multi-level memory and processing hierarchy to exploit data reuse opportunities across multiple loop levels, thus enabling a diverse set of energy-efficient data flows. For example, instead of capturing temporal reuse only for weights or outputs, multi-level dataflows may be implemented that exploit both weight and partial sum reuse during the execution.

To efficiently implement a particular data flow, each local processing element may utilize one or more collectors (e.g., small register-files): one in front of a weight buffer, another one in front of an accumulation buffer, and another in front of an input activation buffer. “Activation buffer” refers to a memory buffer utilized to store activation values (activations) utilized in a neural network computation. Activations are computed by each neuron in a neural network layer using an activation function, also sometimes called a ‘transfer function’. Activations may be simple binary values (e.g., “1” or “0” representing “ON” or “OFF”) or they may take on a range of values for some activation functions. These collectors filter out (reduce) expensive reads and writes to the weight and partial sum buffers (e.g., SRAMs), leading to an overall energy efficiency improvement. The global processing elements and/or the chip may provide additional storage (e.g., a global or shared register file) and processing capability in the data path of neural network computations.

The disclosed DNN processor embodiments provide a heterogeneous-tile-based computational platform for different types neural network calculations. In addition to dense convolution, many neural networks perform element-wise calculation and depth-wise convolution. To facilitate such computations the architecture includes two general types of processing element. The first type, called local processing elements, specialize in executing dense convolution with significant data reuse. The second type, called global processing elements, provide second-level storage for the local processing elements during dense convolution. In addition, the global processing elements may perform element-wise operations and depth-wise convolution at a low compute-to-memory ratio without communicating large amounts of data through layers of the neural network.

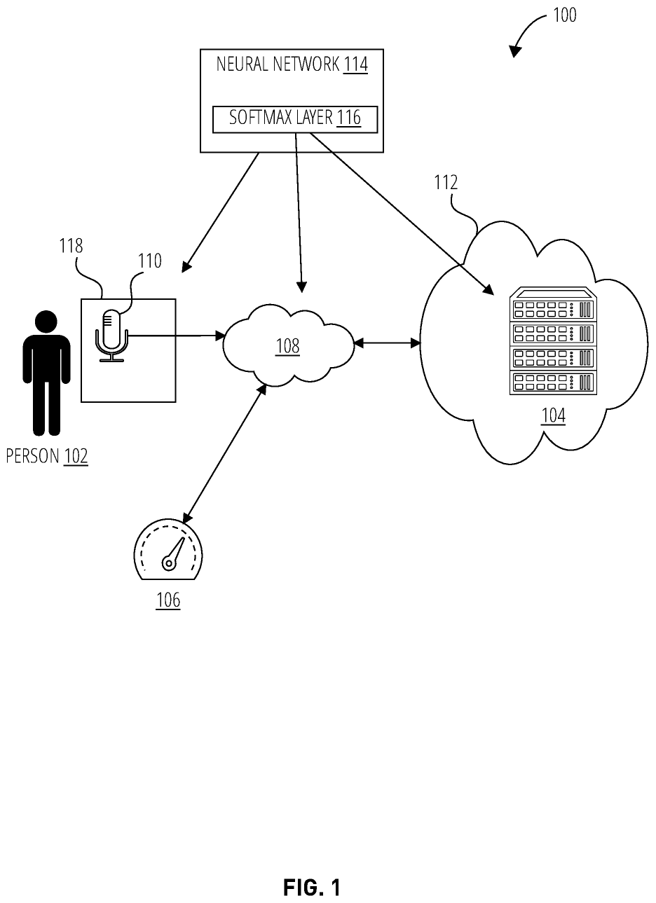

FIG. 1 depicts an exemplary system 100 utilizing artificial neural networks. Neural networks are used extensively in applications such as speech to text conversion, natural language processing, language translation, image recognition and classification and search, and many others.

In the specific example depicted, a person 102 speaks into a microphone 110 of a digital device 118, for example to interact with a voice assistant on a mobile phone or home automation device (e.g., Bixby®, Siri®, Alexa®, Google Assistant® etc.), or in an automobile or with a robot. Voice commands or queries are converted into text and/or commands and communicated to IoT devices 106 and/or cloud computer systems 104, for example over a local area network 108 and/or wide area network 112. The conversion of the speech of the person 102 to text and/or commands understood by the IoT devices 106 and/or cloud computer systems 104 may be carried out by one or more neural networks 114 utilizing one or more Softmax layers 116. Examples of neural networks 114 that may be utilized for these purposes include transformer neural networks, recurrent neural networks, convolutional neural networks, and hybrids of these types, as well as other types known in the art.

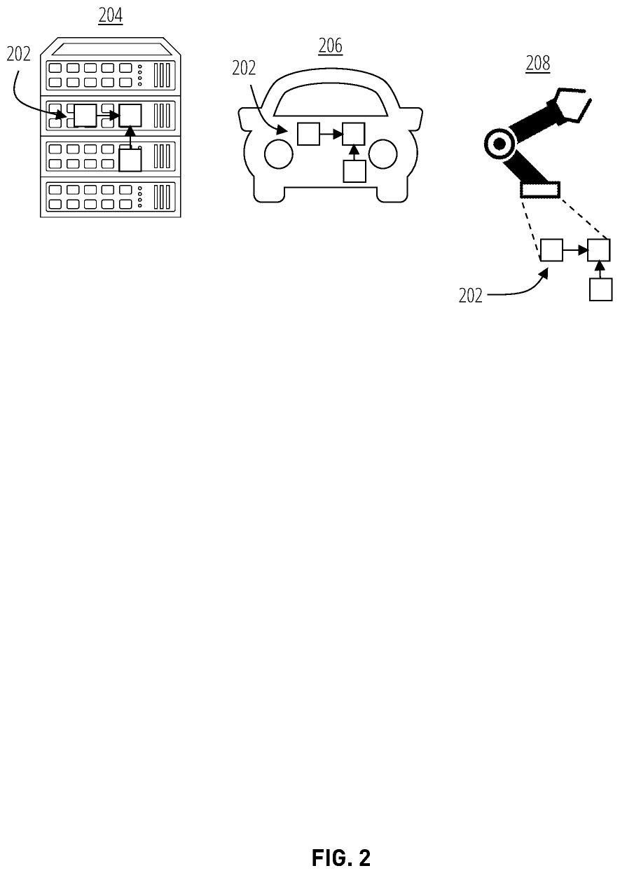

FIG. 2 depicts exemplary scenarios for application of neural networks in a deep learning system 202 utilizing Softmax computation in accordance with some embodiments. A deep learning system 202 may be utilized in a computing system 204, a vehicle 206, and a robot 208, to name a few examples. The deep learning system 202 may comprise one or more neural networks, providing image recognition and classification (machine vision), conversational AI, control systems for self-driving vehicles and robots, and many others.

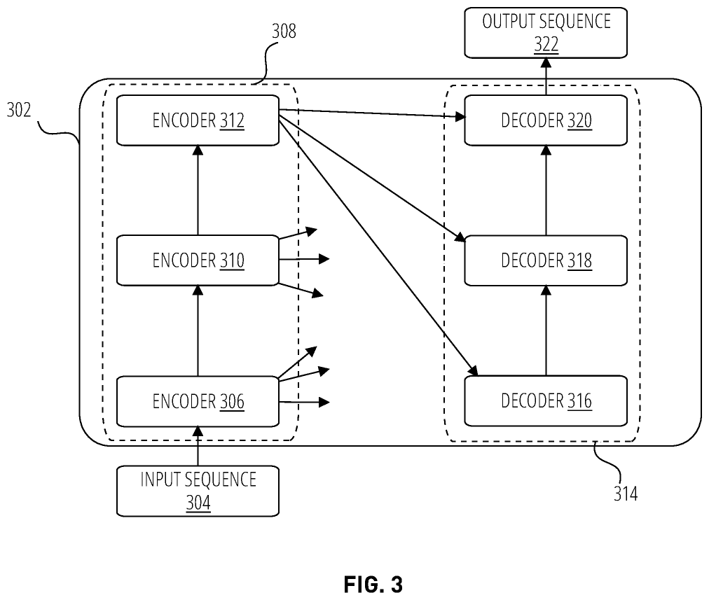

FIG. 3 depicts a transformer neural network 302 in one embodiment. As noted previously, transformer neural networks may utilize Softmax computations extensively in attention layers. The transformer neural network 302 receives an input sequence 304 at a first encoder 306 of an encoder stack 308. The encoder 306 performs an encoding on the input sequence 304 and passes results to the encoder 310, which performs additional encoding and passes results to encoder 312. Although three encoders are depicted in the encoder stack 308, there may be any manageable number in practice.

Results of the last encoder 312 in the encoder stack 308 are provided to the decoder stack 314. The decoder stack 314 as depicted comprises three decoders (decoder 316, decoder 318, and decoder 320) but in practice there may be any manageable number. The encoding results of the final encoder 312 are provided to the first decoder 316 of the decoder stack 314, and the attention results of the final encoder 312 may be fully connected with the encoder-decoder attention layers 504 of each encoder in the decoder stack 314, in one embodiment. The decoder stack 314 operates on the results provided by the encoder stack 308 to generate an output sequence 322 transformation of the input sequence 304. There may typically be linear and Softmax layers (not depicted) at the output of the final decoder 320 stage to produce the output sequence 322.

Generally, attention vectors from any encoder self-attention layer may be provided to any decoder encoder-decoder attention layer. Also the attention layers may be “multi-headed” as known in the art.

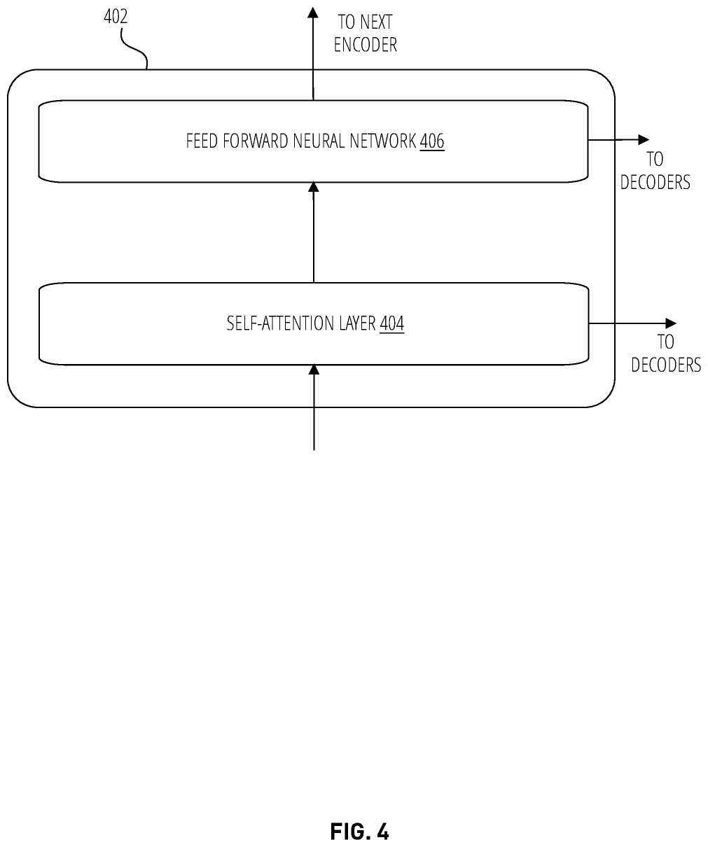

FIG. 4 depict an encoder 402 in one embodiment. The encoder 402 receives input vectors at a self-attention layer 404, which transforms the input vectors before passing them to a feed forward neural network 406. Results of the feed forward neural network 406 are passed to a next encoder stage (if there is one), and/or to decoders if the encoder 402 is a final encoder stage. Depending on the implementation, results of the self-attention layer 404 may also be passed to one or more decoder stages (e.g., if the encoder 402 is a final encoder stage). There may typically be summation and normalization layers (not depicted) following each of the self-attention layer 404 and feed forward neural network 406.

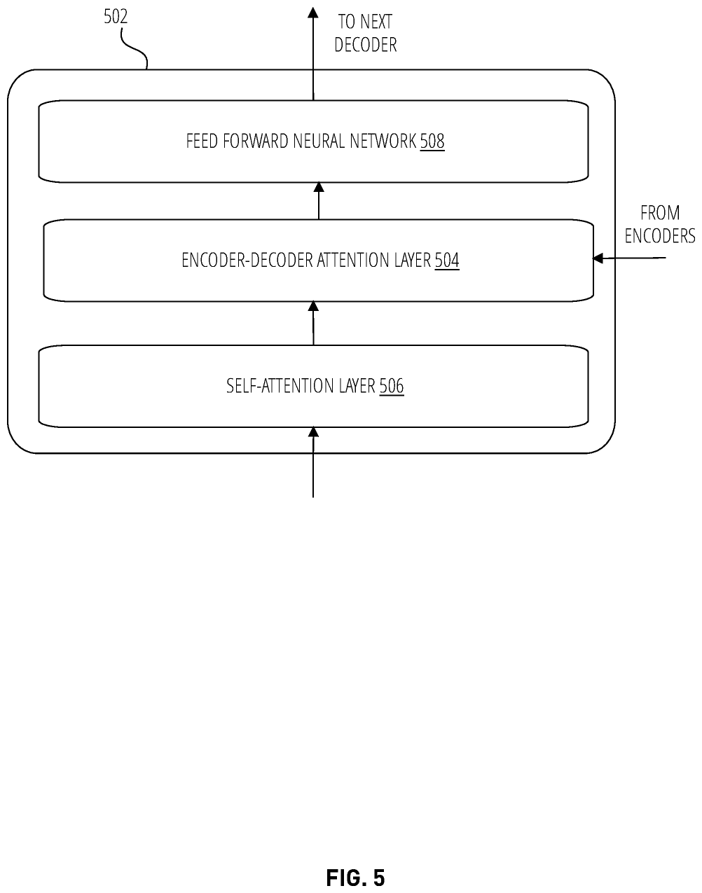

FIG. 5 depict a decoder 502 in one embodiment. The decoder 502 receives inputs (from previous decoder stages or from encoder stages) at a self-attention layer 506. Results of the self-attention layer 506 are passed to an encoder-decoder attention layer 504, which may also receive attention inputs from one or more self-attention layers 404 of the encoder stack 308. The encoder-decoder attention layer 504 helps the decoder 502 focus on more relevant parts of the input sequence at particular locations in the input sequence (similar what attention does in seq2seq models). The encoder-decoder attention layer 504 is followed by a feed forward neural network 508. There may typically be summation and normalization layers (not depicted) following each of the self-attention layer 506, encoder-decoder attention layer 504, and feed forward neural network 508.

Results of the encoder-decoder attention layer 504 are passed to a feed forward neural network 508 that generates outputs to a next decoder stage or final output results (possibly after additional processing by linear and Softmax layers).

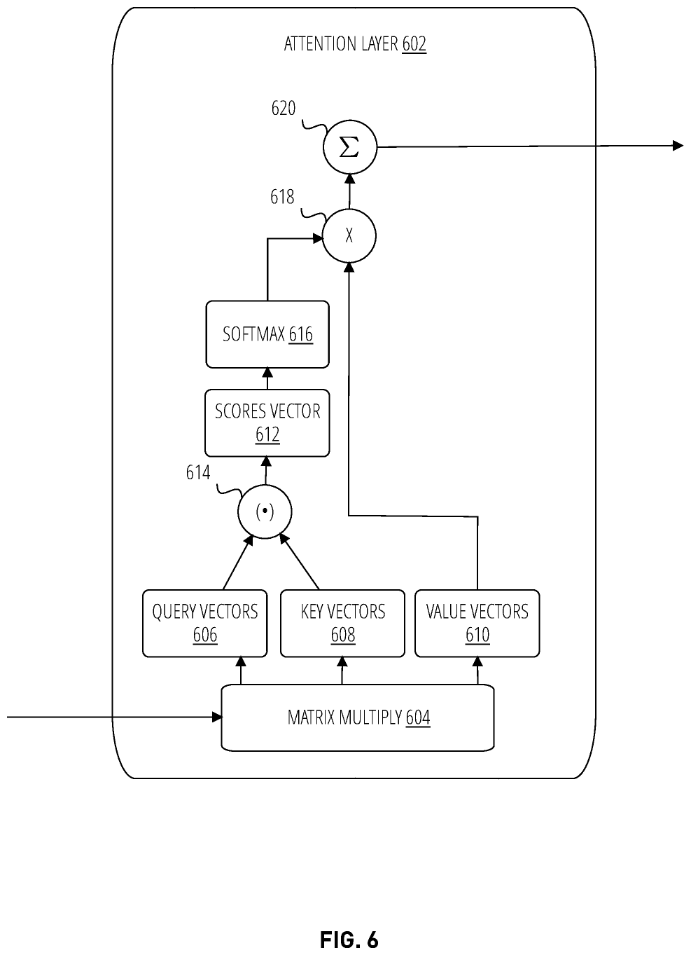

FIG. 6 depicts an attention layer 602 in one embodiment. A matrix multiply 604 is performed on the input vectors to the attention layer 602 to form query vectors 606, key vectors 608, and value vectors 610. The matrices applied in the matrix multiply 604 are derived by training the neural network comprising the attention layer 602.

Next a scores vector 612 is derived by performing a dot product 614 of the query vectors 606 and key vectors 608. The element values in the scores vector 612 determine how much focus to place on other parts (e.g., tokens) of the input vector while processing a particular token of the input vector. The scores vector 612 is then processed with a Softmax 616 algorithm to normalize the scores so they're all positive and add up to 1. The Softmax scores determine how much each token of the input sequence is expressed at the particular input sequence token position.

A multiply 618 is then performed on value vectors 610 by the Softmax score and the weighted value vectors 610 are summed up (vector summation 620).

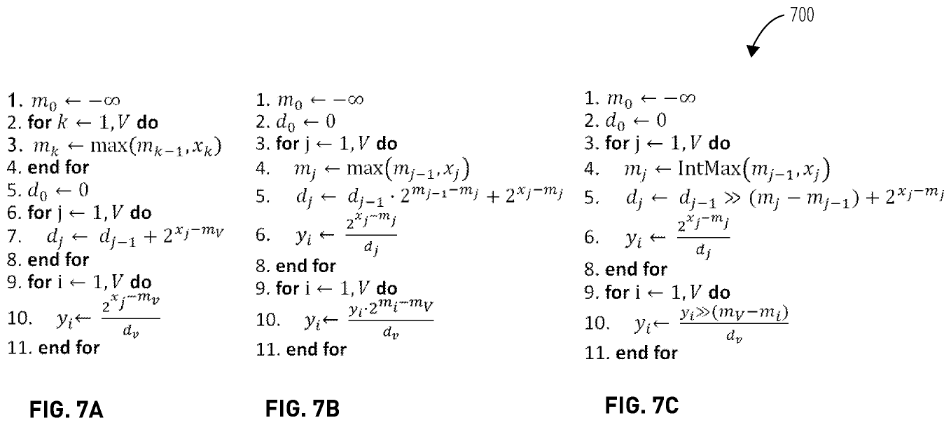

FIG. 7A, FIG. 7B, and FIG. 7C depict an embodiment of a Softmax algorithm 700 that may ameliorate some of the drawbacks of conventional Softmax. At FIG. 7A line 7 computation of the exponential is replaced with more efficient computation of a power of two. The power of two is used for the normalization operation at line 10 in place of the exponential.

In FIG. 7B the computation of the maximum element in the vector V is combined with computation of the vector element summation (lines 3-8) to eliminate one of the three passes over the vector elements V. This results in an unnormalized Softmax vector V that is renormalized in another pass over V at lines 9-11.

In FIG. 7C the computation of the maximum element is computed at integer precision (line 4) which enables the computationally expensive multiply operation in FIG. 7B line 5 to be replaced with a less computationally expensive right shift operation at FIG. 7C line 5. The multiply operation in the renormalization at FIG. 7B line 10 is also replaced by a less expensive right shift at FIG. 7C line 10.

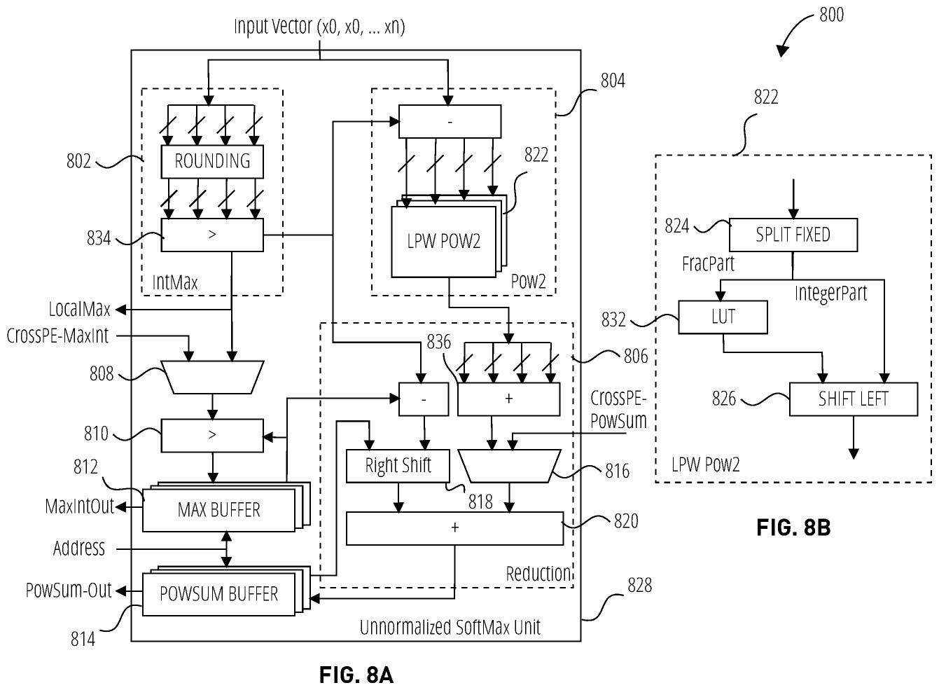

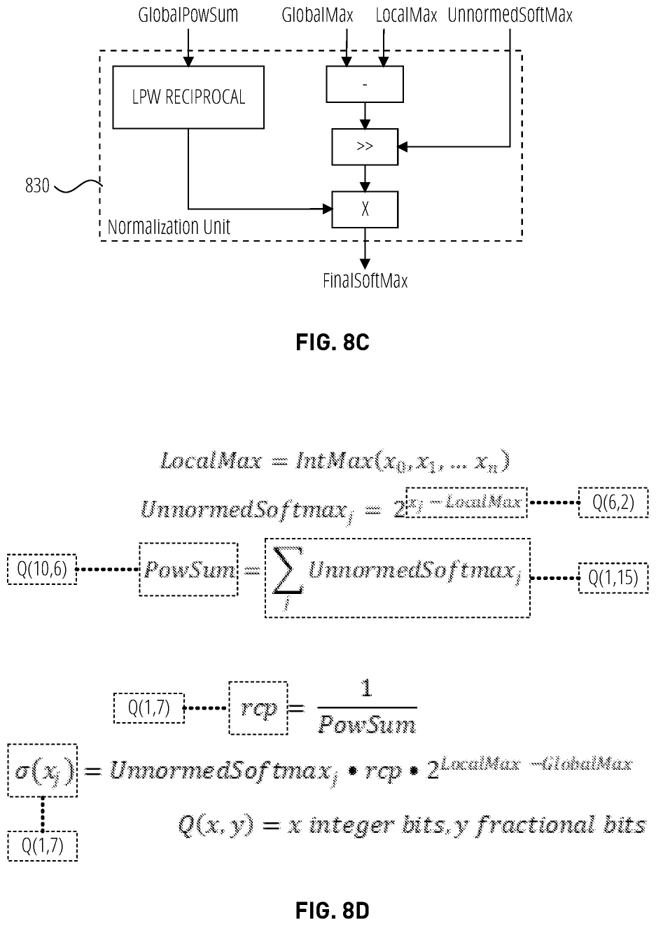

An architecture of an embodiment of an Unnormalized Softmax unit 828 and a Normalization unit 830 is depicted in FIG. 8A through FIG. 8D. These units may cooperate to implement the Softmax algorithm 700, for example. Those of skill in the art will appreciate that these units may be implemented as hardware (e.g., in a special function unit 1912), as firmware, as software, or as combinations thereof (i.e., “logic”). For example, aspects of the units may be implemented in hardware with certain functions (e.g., linear piece-wise approximation) micro-coded as extended ISA (instruction set architecture) instructions for execution by a processor. Some embodiments may implement many or all components of the units in software on high-performance computing platforms.

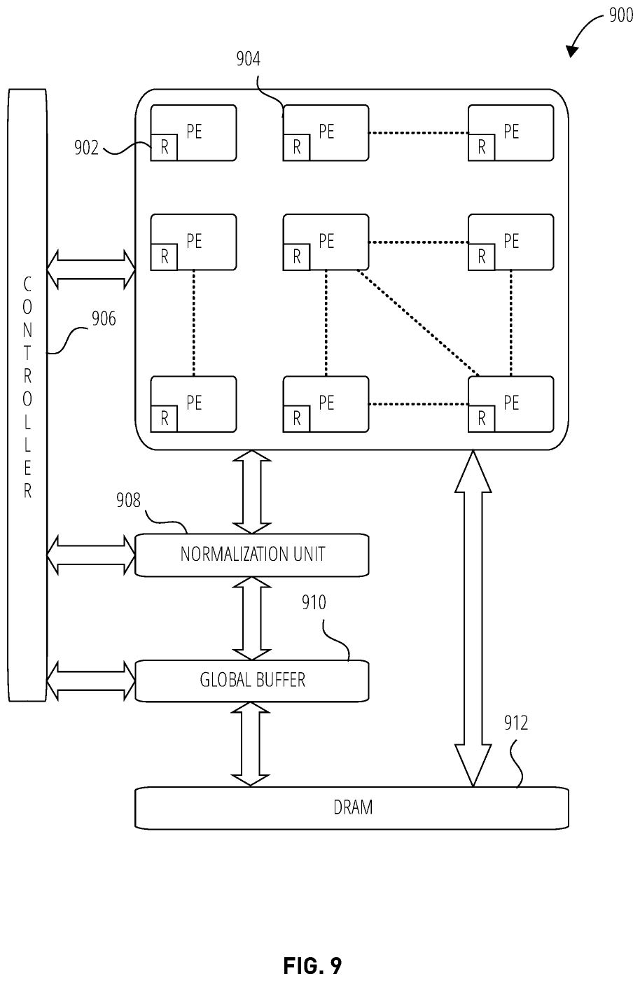

The overall input vector for Softmax may be decomposed into smaller vectors that are fed into the Unnormalized Softmax unit 828. These smaller pieces of the overall vector may be processed in parallel by multiple processing elements (e.g., see FIG. 9), or they may be input and processed sequentially by the Unnormalized Softmax unit 828.

The vector integer maximum unit 802 receives the input vector and computes the integer maximum value (LocalMax) among the vector's elements. Each element of the input vector is rounded to an integer and the maximum valued element after rounding and comparison (max comparator 834) is selected as LocalMax. If the input vector is a fraction of the overall vector to Softmax, then the maximum valued element of the vector is a “local” maximum. This local maximum may be shared among other processing elements working on other segments of the overall vector, for comparison and determination of a global maximum for the vector. In one embodiments, a central processor/controller for coordinating execution of the Softmax algorithm across the processing elements may also collect LocalMax values and determine a global maximum value (GlobalMax) for the vector. “Controller” refers to any logic to control the operation of other logic. When a controller is implemented in hardware, it may for example be one of many well-known models of microprocessor, graphics processing unit, or a custom controller implemented using an application-specific integrated circuit (ASIC), a system-on-a-chip (SOC), or in many other manners known in the art. A controller may also be implemented in software or firmware, as computer instructions stored in a volatile memory or a non-volatile memory. Controllers are typically used to coordinate the operation of one or more other components in a system, for example providing signals to the other components to start and stop their operation, or to instruct the other components with particular commands to carry out.

The power-2 computation unit 804 receives the input vector and the LocalMax value computed by the vector integer maximum unit 802. The power-2 computation unit 804 subtracts LocalMax from each element value x of the input vector and then utilizes the linear piecewise computation unit 822 to compute 2^{(x-LocalMax)}. A low precision micro-architecture may be implemented to improve the computational efficiency (i.e., reduce the computational complexity) in the power-2 computation unit 804. In one embodiment the input vector elements and LocalMax may be implemented in a low precision (meaning lower than typical floating point or long integers) fixed-point representation with six integer bits and two fractional bits. The linear piecewise computation unit 822 may utilize a fixed-point fractional splitter 824 to direct the fractional bits to the look-up table 832 and the integer bits to left shift 826 logic to generate the power of two value.

The linear piecewise computation unit 822 may be implemented using a look-up table 832 comprising, in one embodiment, four entries and ten bits each. The use of IntMax may simplify, in terms of circuit area, power consumption, and computational speed, both the power-2 computation unit 804 and Normalization unit 830. This may simplify the subtraction operation in the power-2 computation unit 804 from floating point to integer and obviate the need for a linear piecewise (LPW) computation of 2^{x} in the Normalization unit 830.

The unnormalized Softmax values generated by the power-2 computation unit 804 may be reduced sequentially in the reduction unit 806 to compute a sum of powers (PowSum). It will be readily apparent to those of ordinary skill in the art how reduction of PowSum across the overall Softmax vector is sequentially carried out in the reduction unit 806 using the vector element adder 836, power sum selector 816 (to select either the power sum from the vector element adder 836 or from another processing element), right shifter 818, and adder 820.

Similarly, reduction of LocalMax values may be performed using max selector 808 and max comparator 810 and the results stored in memory buffer 812. When the sub-vectors of the Softmax computation are spatially distributed across multiple processing elements, cross-processing element (PE) reduction of local PowSum and IntMax values may be performed and shared among processing elements (via memory buffer 812 and power sum buffer 814) to determine global maximums (GlobalMax) and power sums (GlobalPowSum).

The Normalization unit 830 may receive UnnormedSoftmax (unnormalized Softmax vector), LocalMax, GlobalMax, and GlobalPowSum values as input and perform a normalization operation by first computing a reciprocal of GlobalPowSum using a low-precision LPW reciprocal unit that in one embodiment may be implemented as a LUT of size ten bytes. The final Softmax vector elements may be computed by right shifting UnnormedSoftMax vector elements and multiplying with the reciprocal of GlobalPowSum.

By utilizing reduced bit-width operands and reduced LUTs, the implementation cost (in area, power, and/or speed) of a Softmax computation unit may be considerably reduced from the floating-point SFU used for executing similar functions on traditional GPUs. FIG. 8D depicts reduced bit-width values Q(n, m) for one embodiment for various factors in the Softmax computation, where n is the number of integer bits and m is the number of fractional bits.

FIG. 9 depicts a distributed computing system 900 that may be configured to implement a scalable neural network processor in one embodiment. The distributed computing system 900 includes multiple processing elements 904 that communicate values between one another using local router interfaces 902 to carry out distributed neural network computations. Weights for a deep neural network are tiled spatially across local memories of the processing elements 904. The processing elements 904 may be distributed across multiple chips in a single package/device/printed circuit board, or across multiple packages/devices/printed circuit boards.

An overall deep neural network distributed computation is coordinated by a controller 906 with intermediate values of the computation stored in the local memories of the processing elements 904 or in a global global memory buffer 910. “Global memory buffer” refers to a buffer available for utilization by all or at least a plurality of processing elements on a chip. Tensors, weights, and other values for and from the computation may also be read, at least initially, and written from a memory 912 (e.g., a larger but slower DRAM device).

In one embodiment the controller 906 is configured to coordinate the processing elements 904 to perform an Unnormalized Softmax that is then normalized by a normalization unit 908.

Deep neural network applications can differ significantly in their requirements. For example, typical data center inference applications such as image recognition may prioritize performance and scalability at low latency and may be willing to sacrifice classification accuracy, while inference for autonomous driving workloads may prioritize energy efficiency within real-time constraints while maintaining the best achievable network accuracy. The distributed computing system 900 is a general-purpose architecture that may be configured as an application-specific inference accelerator with performance and power advantages compared to general-purpose solutions.

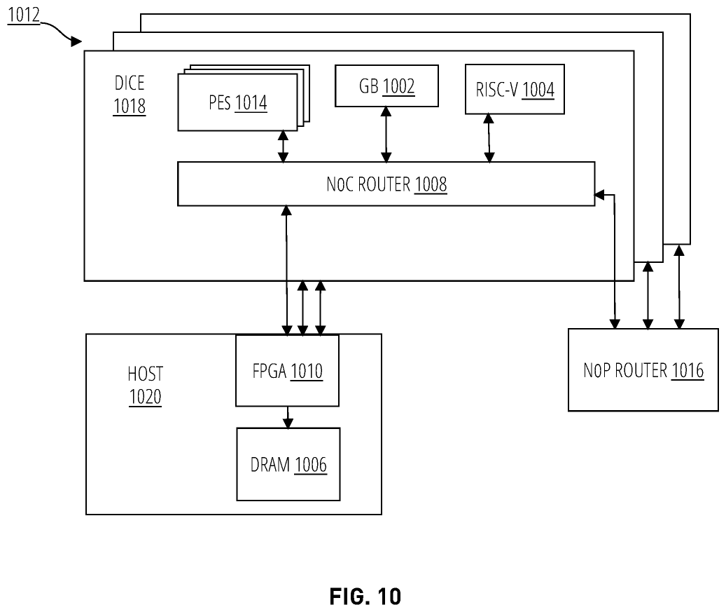

A multi-die package 1012 embodiment for implementing a DNN accelerator is depicted in FIG. 10. The multi-die package 1012 may be a semiconductor package comprising a plurality of dice 1018 (chips). Each of the dice 1018 comprises a plurality of processing elements 1014, a global buffer 1002, and a controller 1004 (e.g., an open-source RISC-V processor). The elements of each chip/die communicate via a network-on-a-chip router 1008. The multiple chips in a package communicate with one another via a network-on-a-package router 1016, and may also communicate with a host 1020 system comprising DRAM 1006 or other memory, via a Field Programmable Gate Array (FPGA 1010), Joint Test Action Group (JTAG) logic, or other interface technology as known in the art.

Some or all of the processing elements are local processing elements comprising a weight buffer to receive and store weight values for a deep neural network. “Weight buffer” refers to a buffer storing weight values. The local processing elements comprise an activation buffer to receive activation values for the deep neural network. The weight buffer and activation buffer may be separate elements within each processing element. The local processing elements further comprise a plurality of multiply-accumulate units to combine, in parallel, the weight values and the activation values, to generate partial sums.

The multi-die package 1012 may be configured to distribute the weight values and the activation values among the local processing elements spatially and temporally (over time). The global memory buffer of each chip may act as a second-level buffer for the activation values during computation. “Second-level buffer” refers a memory where values are stored and retrieved from when the values are needed for computation but are not available in the first-level buffer. Herein, the chip global buffer may act as a second-level buffer to the first-level activation buffers of the chip's processing elements. The distribution of weights and activations during computation may be carried out by the chip's controller 1004. The controller 1004 or local controllers of any of the processing elements 1014 may be configured by instructions stored in a memory to carry out various data flows described below. A memory configured in such a manner may conveniently be referred to herein as “logic”. The location of such logic is a design choice. The memory storing such instructions may be any of the memories depicted in the figures, or a different memory not depicted.

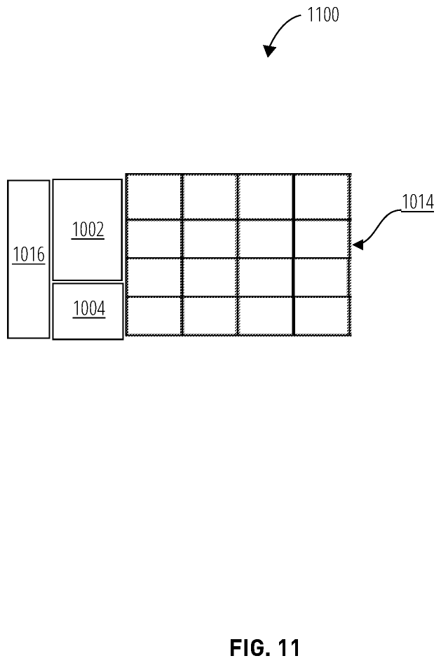

FIG. 11 depicts a neural network processor 1100 embodied on a single chip. The neural network processor 1100 may utilize a fixed point data path between a plurality of processing elements 1014. The neural network processor 1100 also comprises the aforementioned global buffer 1002 and controller 1004, which for example may be a RISC-V processor. The processing elements 1014 and global buffer 1002 communicate via the network-on-a-chip router 1008 or other interconnect technology (see the GPU implementations, described further below). If a router is utilized, it may be implemented centrally or in distributed fashion as routers on each of the processing elements 1014. The processing elements 1014 utilize the router/interconnect to communicate with processing elements on the same package, or in some embodiments across packages via a network-on-a-package router 1016.

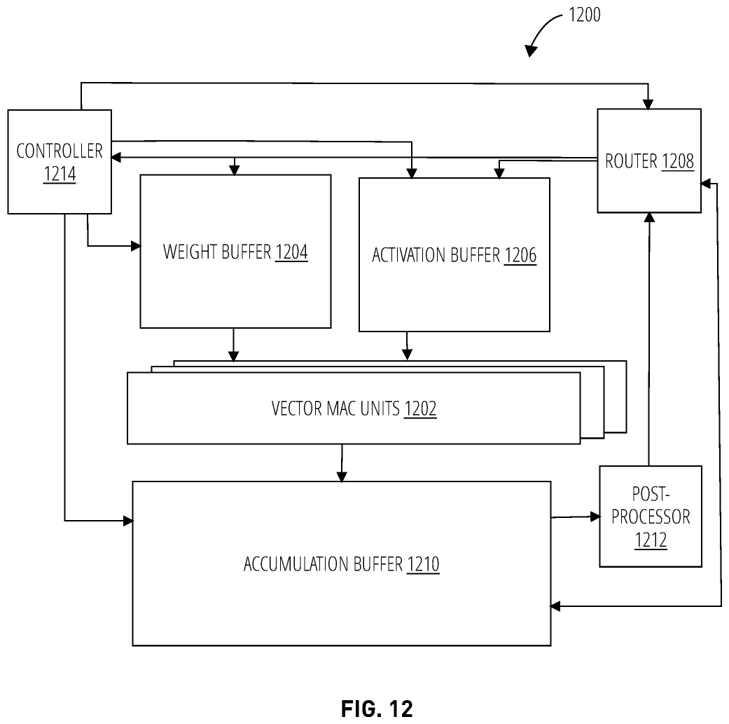

FIG. 12 depicts, and a high level, an exemplary local processing element 1200. The processing element 1200 includes a plurality of vector multiply-accumulate units 1202, a weight buffer 1204, an activation buffer 1206, a router 1208, a controller 1214, an accumulation memory buffer 1210, and a post-processor 1212. “Accumulation memory buffer” refers to a memory buffer utilized to store computational results of one or more multiply-accumulate units. “Post-processor” refers to logic in a neural network calculation applied after multiplication and accumulation. The activation buffer 1206 may, in one embodiment, be implemented as a dual-ported SRAM to receive activation values from the global buffer 1002 or from other local or global processing elements, via the router 1208 or other interconnect. The router 1208 may be a component of a distributed network-on-a-chip router 1008 that in one embodiment comprises a serializer/de-serializer, packetizer, arbitrator, Advanced eXtensible Interface, and other components known in the art.

The weight buffer 1204 may, in one embodiment, be implemented as a single-ported SRAM storing weigh values. The weight values used by the vector multiply-accumulate units 1202 may be “weight-stationary”, meaning they are not updated each clock cycle, but instead are updated once the output activation values are computed for a particular layer of the deep neural network.

The accumulation memory buffer 1210 may comprise one or more SRAM devices to store the output activations computed by the vector multiply-accumulate units 1202. The router 1208 communicates these output activations and control signals from the processing element 1200 to other processing elements.

The processing element 1200 may perform all operations of convolutional and fully-connected layers of a DNN efficiently, including multiply-accumulate, truncation, scaling, bias addition, ReLU, and pooling (these last five in the post-processor 1212). “Bias addition” refers to inclusion of a bias (e.g., a fixed output value or increment to an output value) for one or more neurons of a neural network layer. Bias addition is a technique for ensuring that at least one neuron of a layer produces a non-zero activation to a next layer when the layer does not detect any features in its inputs. The vector multiply-accumulate units 1202 may operate on the same inputs using different filters. In one embodiment, each of the vector multiply-accumulate units 1202 performs an eight-input-channel dot product and accumulates the result into the accumulation memory buffer 1210 on each clock cycle. The weights stored in the weight buffer 1204 are unchanged until the entire computation of output activations completes. Each processing element 1200 reads the input activations in the activation buffer 1206, performs the multiply-accumulate operations, and writes output activations to the accumulation memory buffer 1210 on every clock cycle. The frequency at which the weight buffer 1204 is accessed depends on the input activation matrix dimensions and the number of filters utilized.

The vector multiply-accumulate units 1202 of each processing element 1200 computes a portion of a wide dot-product-accumulate as a partial result and forwards the partial result to neighboring processing elements. “Neighboring processing element” refers to a processing element at a one-hop distance from another processing element on the data communication network fabric, e.g., the network-on-a-chip or network-on-a-package.

The partial results are transformed into a final result by the post-processor 1212 and communicated to the global buffer 1002. The global buffer 1002 acts as a staging area for the final multiply-accumulate results between layers of the deep neural network.

The accumulation memory buffer 1210 receives outputs from the vector multiply-accumulate units 1202. The central controller 1004 distributes the weight values and activation values among the processing elements and utilizes the global memory buffer as a second-level buffer for the activation values. When processing images, the controller 1004 configures processing by layers of the deep neural network spatially across the processing elements by input/output channel dimensions and temporally by image height/width.

The global buffer 1002 stores both input activations and output activations from the processing elements 1014 for distribution by the aforementioned transceivers to the processing elements via multicast. “Multicast” refers to a group communication mechanism whereby transmission of data is addressed to a group of destination devices (e.g., processing elements) simultaneously. Multicast can implement one-to-many or many-to-many distribution. Each of the processing elements 1014 includes a router 1208 to communicate, in one embodiment, 64 bits of data in, and 64 bits of data out, per clock cycle. This enables accumulation of partial sums for wide dot products that have their computation spatially tiled across the processing elements 1014.

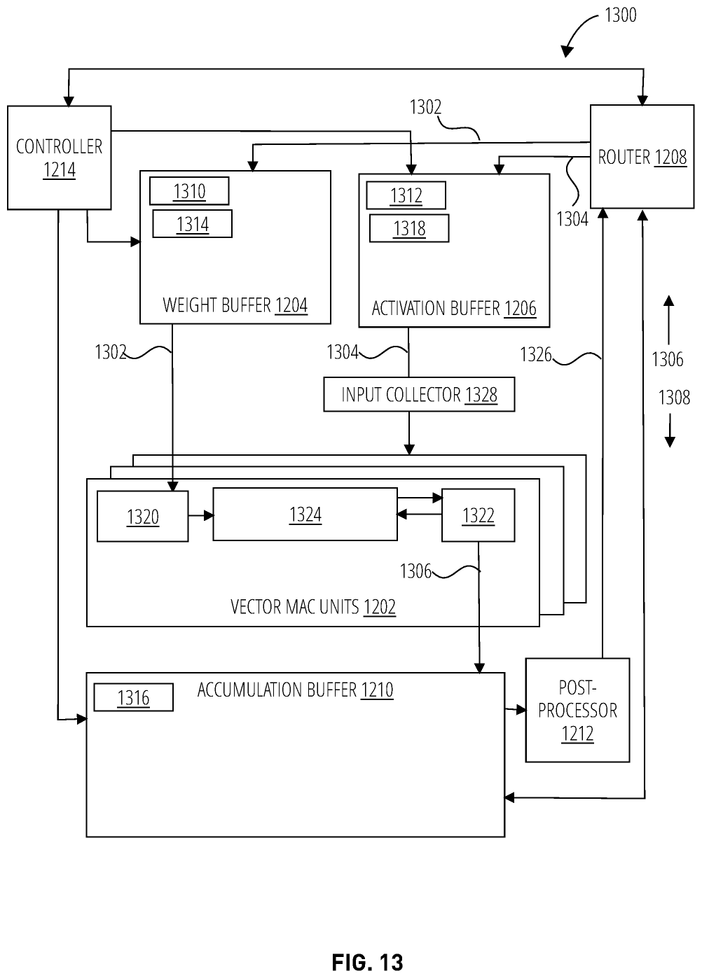

FIG. 13 depicts an exemplary local processing element 1300 in more detail. The processing element 1300 includes the aforementioned vector multiply-accumulate units 1202, weight buffer 1204, activation buffer 1206, router 1208, controller 1214, accumulation memory buffer 1210, and post-processor 1212 (e.g., the post-processor 1212). Also depicted are a weight collector 1320 interposed between the weight buffer 1204 and the vector multiply-accumulate units 1202, and an accumulation collector 1322 interposed between the vector multiply-accumulate units 1202 and the accumulation memory buffer 1210. The accumulation collector 1322 may also be referred to herein as an “output collector”. Also depicted are various memory buffer managers that may be utilized (e.g., weight memory buffer manager 1310, activation memory buffer manager 1312, and accumulation memory buffer manager 1316). “Memory buffer manager” refers to logic for managing the contents of a memory buffer, for example managing the availability of certain data (e.g., weights, activations) in the buffer when requested by a processing element.

The processing element 1300 includes vector multiply-accumulate units 1202 of which a number N are operational for a given data flow. Each vector multiply accumulate unit 1324 performs V multiplications and additions per clock cycle. Thus, in every clock cycle, the processing element 1300 can multiply a weight matrix of dimensions N×V with an input activation vector of size V, to generate a partial-sum vector of size N. In other words, each of the vector multiply-accumulate units 1202 can perform a V-wide dot product calculation per clock cycle. One or both N and V may be configurable at the controller 1004.

The input activation buffer 1206 has an operational size IA and the weight buffer 1204 has an operational size W. “Operational size” refers to a resource pool available for performing calculations during operation of a device, which may be less than the total or maximum size of the resource pool. The operational size may be configurable using registers or other settings (e.g., for higher performance or less power consumption). One or both W and IA may be configurable at the controller 1004. The accumulation memory buffer 1210 has an operational size of A.

Each of the vector multiply-accumulate units 1202 includes a weight collector 1320 buffer having a configurable depth (e.g., number of distinct registers or addresses in a register file used by the vector multiply-accumulate units 1202 during computations) of WD and a width V×N×WP (WP is also called the weight precision). The input activations have width IAP. Each of the vector multiply-accumulate units 1202 also includes an accumulation collector 1322 having a configurable operational depth AD and width N×AP (AP is also called the accumulator precision). The V-wide dot products and N-sized partial-sum vector may thus be computed by each vector multiply accumulate unit 1324 at mixed precision. Some or all of WD, WP, IAP, AD, and AP may be configurable by the controller 1004.

The weight buffer 1204 read (output) port is WP×N×V bits wide and is able to supply different weight vectors to different ones of the vector multiply-accumulate units 1202. The activation buffer 1206 is IAP×V bits wide because the same IA vector is provided in parallel to all N vector multiply-accumulate units 1202.

The values of V and N may be adjusted to enable an amount of computational parallelism and reuse of weights, for example. Based on the configuration of N and V, other parameters such as W, IA, and A may be adjusted to ensure the vector multiply-accumulate units 1202 stay busy during convolution calculation.

The weight buffer 1204 and the activation buffer 1206 each have an associated address generator (address generator 1314 and address generator 1318, respectively) that generates an address every cycle. “Address generator” refers to logic that calculates address values in a memory for reading or writing data from the address. The ordering of operations carried out by the vector multiply-accumulate units 1202 is controlled by these address generators, which are configurable to support temporal reuse of weights or results in the accumulation collector 1322 across clock cycles for different types of data flows. The depth WD of the weight collector 1320 may be configurable to enable different amounts of temporal reuse of partial sum values, depending on the requirements of the data flow. Likewise, the depth AD of the accumulation collector 1322 may be configurable to enable different amounts of temporal reuse of weight values, depending on the requirements of the data flow.

The processing element 1300 may further comprise an input collector 1328 disposed between the activation buffer 1206 and the vector multiply-accumulate units 1202. An operational depth IC of the input collector 1328 may be configured to set different levels of input activation stationary data flows, as described further below.

Each of the weight buffer 1204 and activation buffer 1206 also have a buffer manager (weight memory buffer manager 1310 and activation memory buffer manager 1312, respectively) responsive to the controller 1214 and determining the availability of data to the vector multiply-accumulate units 1202. The dimensions of the address generators and the granularity of data movement from the weight buffer 1204 and activation buffer 1206 to the vector multiply-accumulate units 1202 may in some embodiments be configurable at the controller 1004.

The accumulation memory buffer 1210 stores partial sums from all N vector multiply-accumulate units 1202 and may be optimized to perform read-modify-write operations every cycle. Partial sums from the N vector multiply-accumulate units 1202 are packed into vectors of width AP×N and stored in the accumulation memory buffer 1210. From there, they can be sent either directly to another processing element for cross-processing element reduction or to the post-processor 1212 to produce final output activations. The post-processor 1212 may provide scaling and quantization operations, and additionally ReLU and pooling operations to enable layer fusion.

Input weights 1302 arrive over the router 1208 and are stored in the weight buffer 1204. Input activations 1304 also arrive over the router 1208 and are stored in the activation buffer 1206. Computed output activations 1326 (after post-processing by the post-processor 1212) or partial sums 1306 from the accumulation memory buffer 1210 are output to the global buffer 1002 or neighboring processing elements, respectively, via the router 1208. Cross-processing-element reductions 1308 from said neighboring processing elements may be received by the router 1208 and are accumulated in the accumulation memory buffer 1210. “Cross-processing-element reduction” refers to the reduction of a partial computational result by a first processing element to a final or more complete computational result by one or more other processing elements.

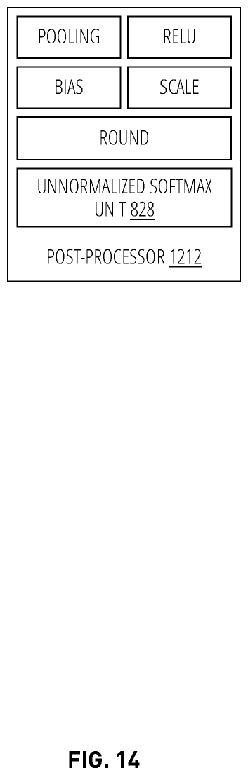

FIG. 14 depicts the post-processor 1212 in one embodiment. The post-processor 1212 may comprise logic (e.g., special function units 1912) for common neural network operations such as pooling, ReLu activation, bias addition, rounding, and scaling. The Unnormalized Softmax unit 828 may in some embodiments be implemented as a special function unit in the post-processors 1212 of the processing processing elements 1014.

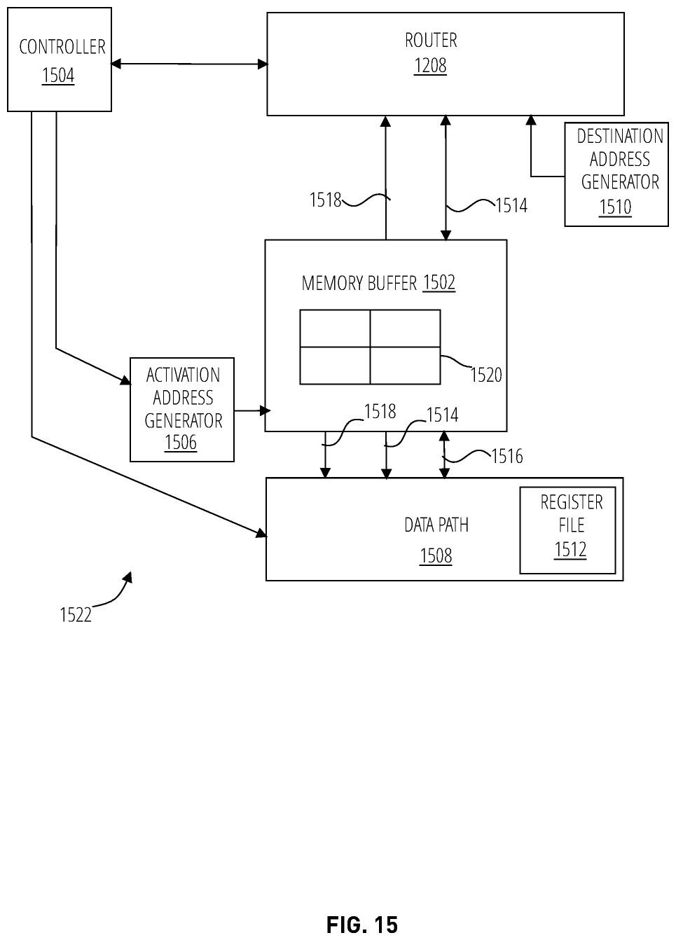

FIG. 15 illustrates the global processing element 1522 in one embodiment. The global processing element 1522 comprises a global memory buffer 1502 with arbitrated memory banks 1520 (e.g., a “scratchpad”), a controller 1504 to carry out calculations on data in the arbitrated memory banks 1520, and an activation address generator 1506 and a destination address generator 1510 to generate source and destination addresses, respectively, for calculations. “Memory bank” refers to a logical unit of memory storage. The memory bank may be determined by the memory controller along with physical organization of the hardware memory interfaces. In a typical synchronous dynamic random-access memory (SDRAM) or double data rate synchronous dynamic random-access memory (DDR SDRAM), a memory bank comprises of multiple rows and columns of storage units, and may be spread out across several memory chips. The global processing element 1522 communicates with other processing elements via the router 1208.

The data path 1508 to and from the global memory buffer 1502 comprises a register file 1512 which may operate as a collector for one or more of input activations 1518, output activations 1514, and partial sums 1516 to and from local processing elements, according to the requirements of the data flow.

Many neural networks utilize computations such as element-wise calculation and depth-wise convolution for improved overall accuracy. Local processing elements are specialized for executing dense convolution with significant data reuse. The global buffer 1002 may be utilized as the second-level data storage by local processing elements during dense convolution and may also perform computation for element-wise operations and depth-wise convolution. Global processing elements execute computation with low compute-to-memory ratio locally without communicating the data through layers (and hence, chips) of the neural network.

The controller 1504 may be local to each global processing element 1522 or may be implemented by the chip master controller (controller 1004). Likewise, the global memory buffer 1502 may be local to the global processing element 1522 or implemented by the global buffer 1002.

The algorithms and techniques disclosed herein may be executed by computing devices utilizing at least one graphic processing unit (GPU) and/or general purpose data processor (e.g., a ‘central processing unit or CPU). Exemplary architectures is described that may be configured to carry out the techniques disclosed herein on such devices.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

### Parallel Processing Unit

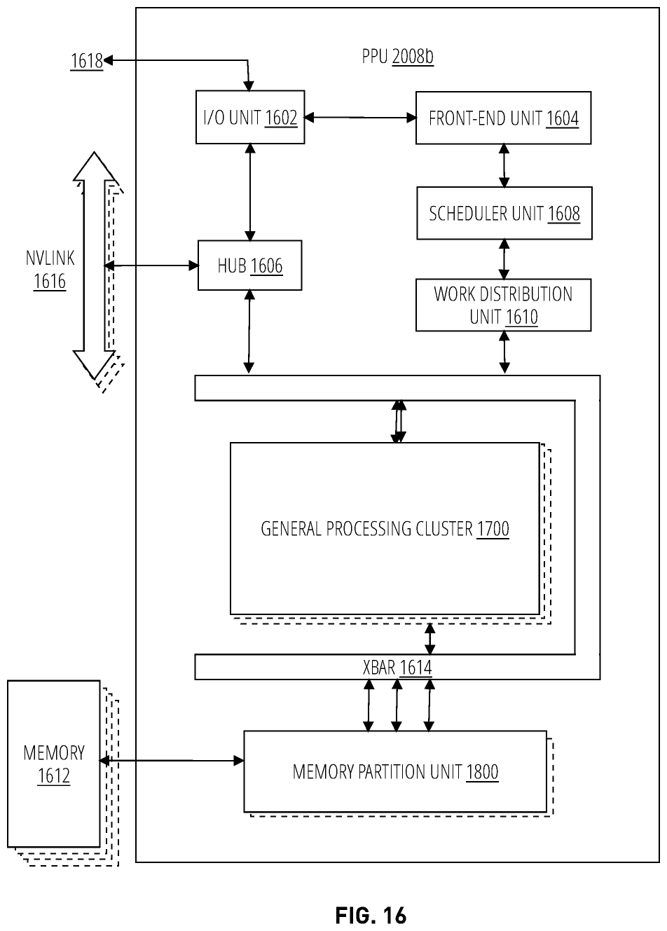

FIG. 16 depicts a parallel processing unit 2008b, in accordance with an embodiment. In an embodiment, the parallel processing unit 2008b is a multi-threaded processor that is implemented on at least one integrated circuit device. The parallel processing unit 2008b is a latency hiding architecture designed to process many threads in parallel. A thread (e.g., a thread of execution) is an instantiation of a set of instructions configured to be executed by the parallel processing unit 2008b. In an embodiment, the parallel processing unit 2008b is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 2008b may be utilized for performing general-purpose computations. While one exemplary parallel processor is provided herein for illustrative purposes, it should be noted that such processor is set forth for illustrative purposes, and that any processor may be employed to supplement and/or substitute for the that set forth here.

At least one parallel processing unit 2008b module may be configured to accelerate thousands of High Performance Computing (HPC), data center, and machine learning applications. The parallel processing unit 2008b may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 16, the parallel processing unit 2008b includes an I/O unit 1602, a front-end unit 1604, a scheduler unit 1608, a work distribution unit 1610, a hub 1606, a crossbar 1614, at least one general processing cluster 1700 module, and at least one memory partition unit 1800 modules. The parallel processing unit 2008b may be connected to a host processor or other parallel processing unit 2008b modules via at least one high-speed NVLink 1616 interconnect. The parallel processing unit 2008b may be connected to a host processor or other peripheral devices via an interconnect 1618. The parallel processing unit 2008b may also be connected to a local memory comprising a number of memory 1612 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 1612 may comprise logic to configure the parallel processing unit 2008b to carry out aspects of the techniques disclosed herein.

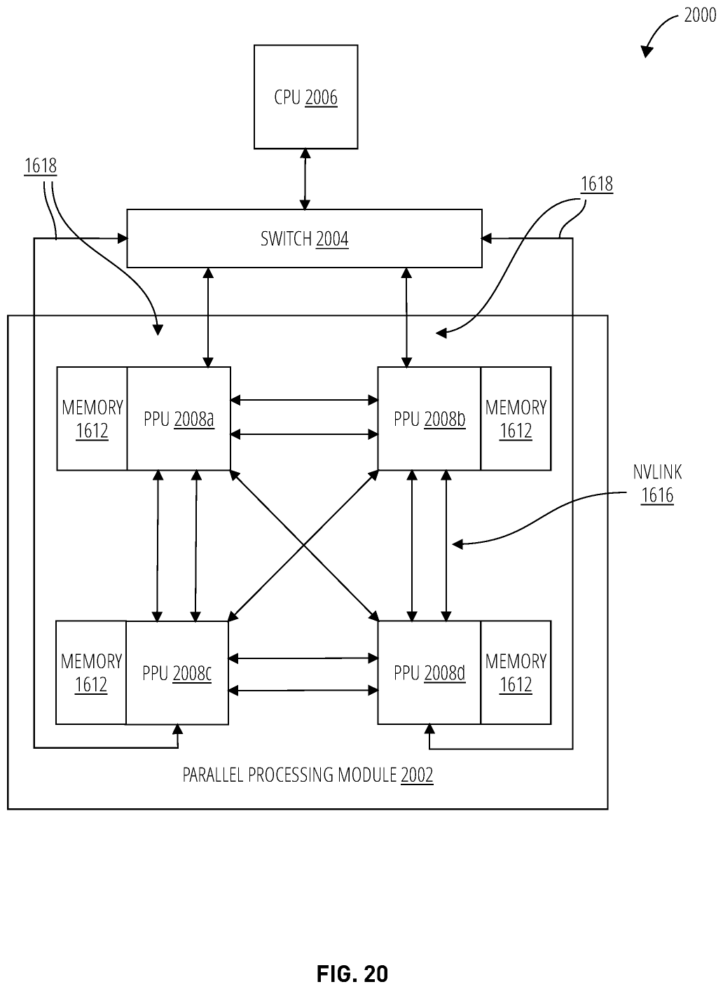

The NVLink 1616 interconnect enables systems to scale and include at least one parallel processing unit 2008b module combined with at least one CPU, supports cache coherence between the parallel processing unit 2008b modules and CPUs, and CPU mastering. Data and/or commands may be transmitted by the NVLink 1616 through the hub 1606 to/from other units of the parallel processing unit 2008b such as at least one copy engine, a video encoder, a video decoder, a power management unit, etc. (not explicitly shown). The NVLink 1616 is described in more detail in conjunction with FIG. 20.

The I/O unit 1602 is configured to transmit and receive communications (e.g., commands, data, etc.) from a host processor (not shown) through the interconnect 1618. The I/O unit 1602 may communicate with the host processor directly via the interconnect 1618 or through at least one intermediate device such as a memory bridge. In an embodiment, the I/O unit 1602 may communicate with at least one other processor, such as at least one parallel processing unit 2008b module via the interconnect 1618. In an embodiment, the I/O unit 1602 implements a Peripheral Component Interconnect Express (PCIe) interface for communications through a PCIe bus and the interconnect 1618 is a PCIe bus. In alternative embodiments, the I/O unit 1602 may implement other types of well-known interfaces for communicating with external devices.

The I/O unit 1602 decodes packets received via the interconnect 1618. In an embodiment, the packets represent commands configured to cause the parallel processing unit 2008b to perform various operations. The I/O unit 1602 transmits the decoded commands to various other units of the parallel processing unit 2008b as the commands may specify. For example, some commands may be transmitted to the front-end unit 1604. Other commands may be transmitted to the hub 1606 or other units of the parallel processing unit 2008b such as at least one copy engine, a video encoder, a video decoder, a power management unit, etc. (not explicitly shown). In other words, the I/O unit 1602 is configured to route communications between and among the various logical units of the parallel processing unit 2008b.

In an embodiment, a program executed by the host processor encodes a command stream in a buffer that provides workloads to the parallel processing unit 2008b for processing. A workload may comprise several instructions and data to be processed by those instructions. The buffer is a region in a memory that is accessible (e.g., read/write) by both the host processor and the parallel processing unit 2008b. For example, the I/O unit 1602 may be configured to access the buffer in a system memory connected to the interconnect 1618 via memory requests transmitted through the interconnect 1618. In an embodiment, the host processor writes the command stream to the buffer and then transmits a pointer to the start of the command stream to the parallel processing unit 2008b. The front-end unit 1604 receives pointers to at least one command stream. The front-end unit 1604 manages the at least one stream, reading commands from the streams and forwarding commands to the various units of the parallel processing unit 2008b.

The front-end unit 1604 is coupled to a scheduler unit 1608 that configures the various general processing cluster 1700 modules to process tasks defined by the at least one stream. The scheduler unit 1608 is configured to track state information related to the various tasks managed by the scheduler unit 1608. The state may indicate which general processing cluster 1700 a task is assigned to, whether the task is active or inactive, a priority level associated with the task, and so forth. The scheduler unit 1608 manages the execution of a plurality of tasks on the at least one general processing cluster 1700 module.

The scheduler unit 1608 is coupled to a work distribution unit 1610 that is configured to dispatch tasks for execution on the general processing cluster 1700 modules. The work distribution unit 1610 may track a number of scheduled tasks received from the scheduler unit 1608. In an embodiment, the work distribution unit 1610 manages a pending task pool and an active task pool for each of the general processing cluster 1700 modules. The pending task pool may comprise a number of slots (e.g., 32 slots) that comprise tasks assigned to be processed by a particular general processing cluster 1700. The active task pool may comprise a number of slots (e.g., 4 slots) for tasks that are actively being processed by the general processing cluster 1700 modules. As a general processing cluster 1700 finishes the execution of a task, that task is evicted from the active task pool for the general processing cluster 1700 and one of the other tasks from the pending task pool is selected and scheduled for execution on the general processing cluster 1700. If an active task has been idle on the general processing cluster 1700, such as while waiting for a data dependency to be resolved, then the active task may be evicted from the general processing cluster 1700 and returned to the pending task pool while another task in the pending task pool is selected and scheduled for execution on the general processing cluster 1700.

The work distribution unit 1610 communicates with the at least one general processing cluster 1700 module via crossbar 1614. The crossbar 1614 is an interconnect network that couples many of the units of the parallel processing unit 2008b to other units of the parallel processing unit 2008b. For example, the crossbar 1614 may be configured to couple the work distribution unit 1610 to a particular general processing cluster 1700. Although not shown explicitly, at least one other unit of the parallel processing unit 2008b may also be connected to the crossbar 1614 via the hub 1606.

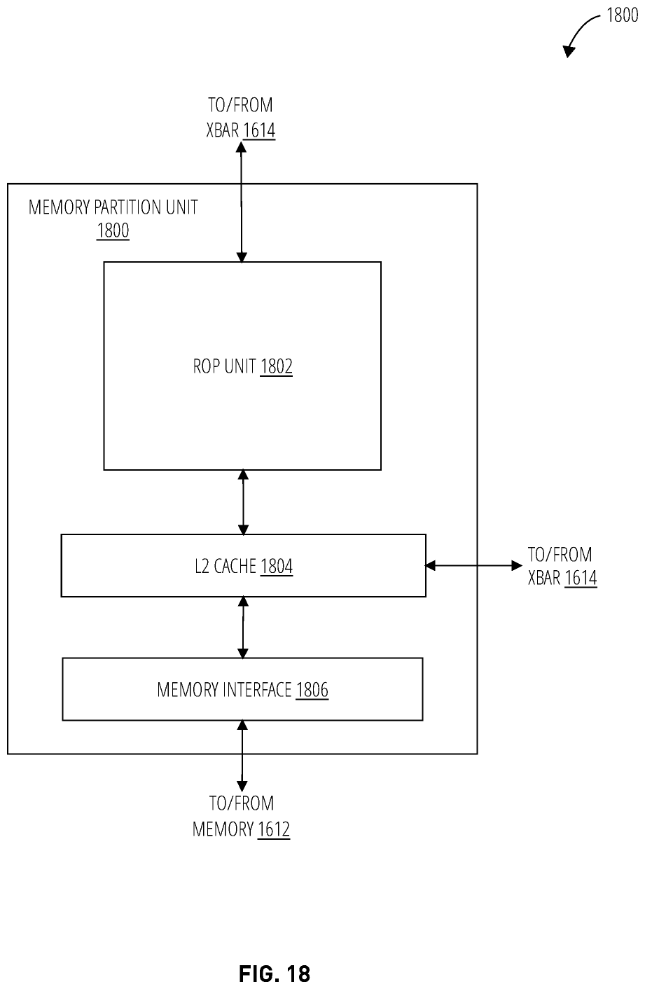

The tasks are managed by the scheduler unit 1608 and dispatched to a general processing cluster 1700 by the work distribution unit 1610. The general processing cluster 1700 is configured to process the task and generate results. The results may be consumed by other tasks within the general processing cluster 1700, routed to a different general processing cluster 1700 via the crossbar 1614, or stored in the memory 1612. The results can be written to the memory 1612 via the memory partition unit 1800 modules, which implement a memory interface for reading and writing data to/from the memory 1612. The results can be transmitted to another parallel processing unit 2008b or CPU via the NVLink 1616. In an embodiment, the parallel processing unit 2008b includes a number U of memory partition unit 1800 modules that is equal to the number of separate and distinct memory 1612 devices coupled to the parallel processing unit 2008b. A memory partition unit 1800 is described in further detail in conjunction with FIG. 18.

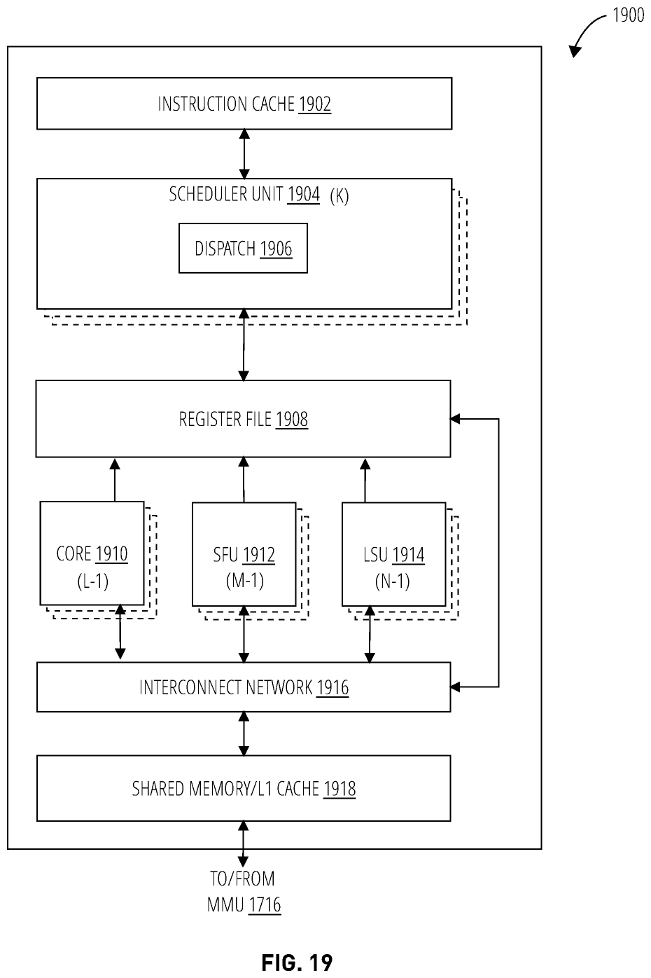

In an embodiment, a host processor executes a driver kernel that implements an application programming interface (API) that enables applications executing on the host processor to schedule operations for execution on the parallel processing unit 2008b. In an embodiment, multiple compute applications are simultaneously executed by the parallel processing unit 2008b and the parallel processing unit 2008b provides isolation, quality of service (QoS), and independent address spaces for the multiple compute applications. An application may generate instructions (e.g., API calls) that cause the driver kernel to generate tasks for execution by the parallel processing unit 2008b. The driver kernel outputs tasks to streams being processed by the parallel processing unit 2008b. Each task may comprise at least one group of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described further in conjunction with FIG. 19.

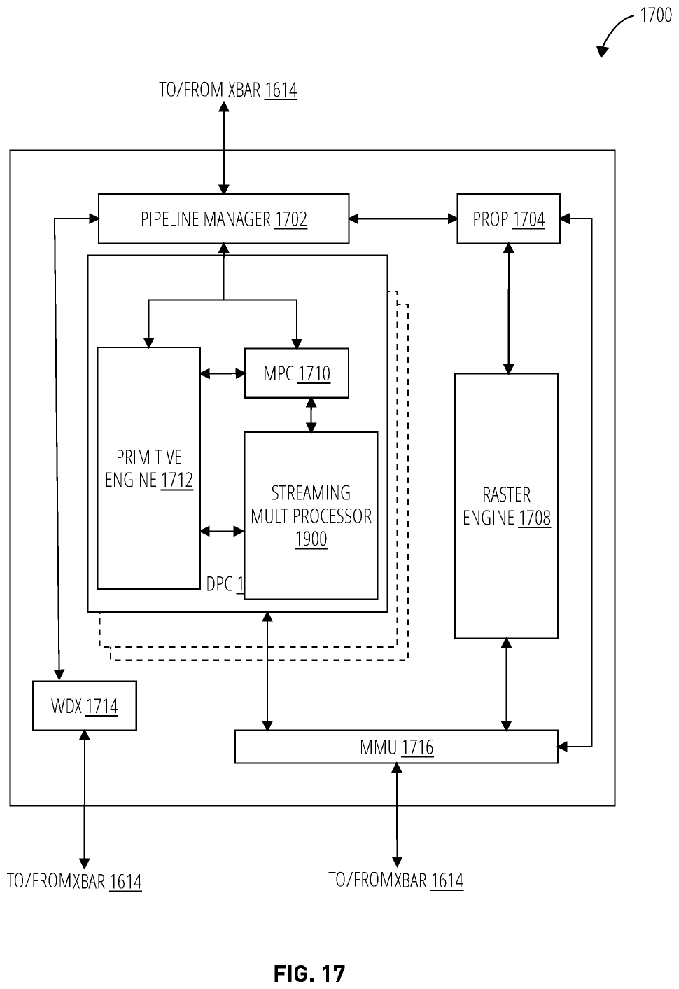

FIG. 17 depicts a general processing cluster 1700 of the parallel processing unit 2008b of FIG. 16, in accordance with an embodiment. As shown in FIG. 17, each general processing cluster 1700 includes a number of hardware units for processing tasks. In an embodiment, each general processing cluster 1700 includes a pipeline manager 1702, a pre-raster operations unit 1704, a raster engine 1708, a work distribution crossbar 1714, a memory management unit 1716, and at least one data processing cluster 1706. It may be appreciated that the general processing cluster 1700 of FIG. 17 may include other hardware units in lieu of or in addition to the units shown in FIG. 17.

In an embodiment, the operation of the general processing cluster 1700 is controlled by the pipeline manager 1702. The pipeline manager 1702 manages the configuration of the at least one data processing cluster 1706 module for processing tasks allocated to the general processing cluster 1700. In an embodiment, the pipeline manager 1702 may configure at least one of the data processing cluster 1706 modules to implement at least a portion of a graphics rendering pipeline. For example, a data processing cluster 1706 may be configured to execute a vertex shader program on the programmable streaming multiprocessor 1900. The pipeline manager 1702 may also be configured to route packets received from the work distribution unit 1610 to the appropriate logical units within the general processing cluster 1700. For example, some packets may be routed to fixed function hardware units in the pre-raster operations unit 1704 and/or raster engine 1708 while other packets may be routed to the data processing cluster 1706 modules for processing by the primitive engine 1712 or the streaming multiprocessor 1900. In an embodiment, the pipeline manager 1702 may configure at least one of the data processing cluster 1706 modules to implement a neural network model and/or a computing pipeline.

The pre-raster operations unit 1704 is configured to route data generated by the raster engine 1708 and the data processing cluster 1706 modules to a Raster Operations (ROP) unit, described in detail in conjunction with FIG. 18. The pre-raster operations unit 1704 may also be configured to perform improved operations for color blending, organize pixel data, perform address translations, and the like.

The raster engine 1708 includes a number of fixed function hardware units configured to perform various raster operations. In an embodiment, the raster engine 1708 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 1708 comprises fragments to be processed, for example, by a fragment shader implemented within a data processing cluster 1706.

Each data processing cluster 1706 included in the general processing cluster 1700 includes an M-pipe controller 1710, a primitive engine 1712, and at least one streaming multiprocessor 1900 modules. The M-pipe controller 1710 controls the operation of the data processing cluster 1706, routing packets received from the pipeline manager 1702 to the appropriate units in the data processing cluster 1706. For example, packets associated with a vertex may be routed to the primitive engine 1712, which is configured to fetch vertex attributes associated with the vertex from the memory 1612. In contrast, packets associated with a shader program may be transmitted to the streaming multiprocessor 1900.

The streaming multiprocessor 1900 comprises a programmable streaming processor that is configured to process tasks represented by a number of threads. Each streaming multiprocessor 1900 is multi-threaded and configured to execute a plurality of threads (e.g., 32 threads) from a particular group of threads concurrently. In an embodiment, the streaming multiprocessor 1900 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 1900 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 1900 is described in detail in conjunction with FIG. 19.

The memory management unit 1716 provides an interface between the general processing cluster 1700 and the memory partition unit 1800. The memory management unit 1716 may provide translation of virtual addresses into physical addresses, memory protection, and arbitration of memory requests. In an embodiment, the memory management unit 1716 provides one or more translation lookaside buffers (TLBs) for performing translation of virtual addresses into physical addresses in the memory 1612.

FIG. 18 depicts a memory partition unit 1800 of the parallel processing unit 2008b of FIG. 16, in accordance with an embodiment. As shown in FIG. 18, the memory partition unit 1800 includes a raster operations unit 1802, a level two cache 1804, and a memory interface 1806. The memory interface 1806 is coupled to the memory 1612. Memory interface 1806 may implement 32, 64, 128, 1024-bit data buses, or the like, for high-speed data transfer. In an embodiment, the parallel processing unit 2008b incorporates U memory interface 1806 modules, one memory interface 1806 per pair of memory partition unit 1800 modules, where each pair of memory partition unit 1800 modules is connected to a corresponding memory 1612 device. For example, parallel processing unit 2008b may be connected to up to Y memory 1612 devices, such as high bandwidth memory stacks or graphics double-data-rate, version 5, synchronous dynamic random access memory, or other types of persistent storage.

In an embodiment, the memory interface 1806 implements an HBM2 memory interface and Y equals half U. In an embodiment, the HBM2 memory stacks are located on the same physical package as the parallel processing unit 2008b, providing substantial power and area savings compared with traditional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 1612 supports Single-Error Correcting Double-Error Detecting (SECDED) Error Correction Code (ECC) to protect data. ECC provides improved reliability for compute applications that are sensitive to data corruption. Reliability is especially important in large-scale cluster computing environments where parallel processing unit 2008b modules process extensive datasets and/or run applications for extended periods.

In an embodiment, the parallel processing unit 2008b implements a multi-level memory hierarchy. In an embodiment, the memory partition unit 1800 supports a unified memory to provide a single unified virtual address space for CPU and parallel processing unit 2008b memory, enabling data sharing between virtual memory systems. In an embodiment the frequency of accesses by a parallel processing unit 2008b to memory located on other processors is traced to ensure that memory pages are moved to the physical memory of the parallel processing unit 2008b that is accessing the pages more frequently. In an embodiment, the NVLink 1616 supports address translation services allowing the parallel processing unit 2008b to directly access a CPU's page tables and providing full access to CPU memory by the parallel processing unit 2008b.

In an embodiment, copy engines transfer data between multiple parallel processing unit 2008b modules or between parallel processing unit 2008b modules and CPUs. The copy engines can generate page faults for addresses that are not mapped into the page tables. The memory partition unit 1800 can then service the page faults, mapping the addresses into the page table, after which the copy engine can perform the transfer. In a traditional system, memory is pinned (e.g., non-pageable) for multiple copy engine operations between multiple processors, reducing the available memory. With hardware page faulting, addresses can be passed to the copy engines without worrying if the memory pages are resident, and the copy process is transparent.

Data from the memory 1612 or other system memory may be fetched by the memory partition unit 1800 and stored in the level two cache 1804, which is located on-chip and is shared between the various general processing cluster 1700 modules. As shown, each memory partition unit 1800 includes a portion of the level two cache 1804 associated with a corresponding memory 1612 device. Lower level caches may then be implemented in various units within the general processing cluster 1700 modules. For example, each of the streaming multiprocessor 1900 modules may implement an L1 cache. The L1 cache is private memory that is dedicated to a particular streaming multiprocessor 1900. Data from the level two cache 1804 may be fetched and stored in each of the L1 caches for processing in the functional units of the streaming multiprocessor 1900 modules. The level two cache 1804 is coupled to the memory interface 1806 and the crossbar 1614.

The raster operations unit 1802 performs graphics raster operations related to pixel color, such as color compression, pixel blending, and the like. The raster operations unit 1802 also implements depth testing in conjunction with the raster engine 1708, receiving a depth for a sample location associated with a pixel fragment from the culling engine of the raster engine 1708. The depth is tested against a corresponding depth in a depth buffer for a sample location associated with the fragment. If the fragment passes the depth test for the sample location, then the raster operations unit 1802 updates the depth buffer and transmits a result of the depth test to the raster engine 1708. It will be appreciated that the number of partition memory partition unit 1800 modules may be different than the number of general processing cluster 1700 modules and, therefore, each raster operations unit 1802 may be coupled to each of the general processing cluster 1700 modules. The raster operations unit 1802 tracks packets received from the different general processing cluster 1700 modules and determines which general processing cluster 1700 that a result generated by the raster operations unit 1802 is routed to through the crossbar 1614. Although the raster operations unit 1802 is included within the memory partition unit 1800 in FIG. 18, in other embodiment, the raster operations unit 1802 may be outside of the memory partition unit 1800. For example, the raster operations unit 1802 may reside in the general processing cluster 1700 or another unit.

FIG. 19 depicts the streaming multiprocessor 1900 of FIG. 17, in accordance with an embodiment. As shown in FIG. 19, the streaming multiprocessor 1900 includes an instruction cache 1902, one or more scheduler unit 1904 modules (e.g., such as scheduler unit 1608), a register file 1908, one or more processing core 1910 modules, one or more special function unit 1912 modules, one or more load/store unit 1914 modules, an interconnect network 1916, and a shared memory/L1 cache 1918.

As described above, the work distribution unit 1610 dispatches tasks for execution on the general processing cluster 1700 modules of the parallel processing unit 2008b. The tasks are allocated to a particular data processing cluster 1706 within a general processing cluster 1700 and, if the task is associated with a shader program, the task may be allocated to a streaming multiprocessor 1900. The scheduler unit 1608 receives the tasks from the work distribution unit 1610 and manages instruction scheduling for one or more thread blocks assigned to the streaming multiprocessor 1900. The scheduler unit 1904 schedules thread blocks for execution as warps of parallel threads, where each thread block is allocated at least one warp. In an embodiment, each warp executes 32 threads. The scheduler unit 1904 may manage a plurality of different thread blocks, allocating the warps to the different thread blocks and then dispatching instructions from the plurality of different cooperative groups to the various functional units (e.g., core 1910 modules, special function unit 1912 modules, and load/store unit 1914 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Traditional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable improved performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 1906 unit is configured within the scheduler unit 1904 to transmit instructions to one or more of the functional units. In one embodiment, the scheduler unit 1904 includes two dispatch 1906 units that enable two different instructions from the same warp to be dispatched during each clock cycle. In alternative embodiments, each scheduler unit 1904 may include a single dispatch 1906 unit or additional dispatch 1906 units.

Each streaming multiprocessor 1900 includes a register file 1908 that provides a set of registers for the functional units of the streaming multiprocessor 1900. In an embodiment, the register file 1908 is divided between each of the functional units such that each functional unit is allocated a dedicated portion of the register file 1908. In another embodiment, the register file 1908 is divided between the different warps being executed by the streaming multiprocessor 1900. The register file 1908 provides temporary storage for operands connected to the data paths of the functional units.

Each streaming multiprocessor 1900 comprises L processing core 1910 modules. In an embodiment, the streaming multiprocessor 1900 includes a large number (e.g., 128, etc.) of distinct processing core 1910 modules. Each core 1910 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 1910 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 1910 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply takes 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 1900 also comprises M special function unit 1912 modules that perform special functions (e.g., attribute evaluation, reciprocal square root, and the like). In an embodiment, the special function unit 1912 modules may include a tree traversal unit configured to traverse a hierarchical tree data structure. In an embodiment, the special function unit 1912 modules may include texture unit configured to perform texture map filtering operations. In an embodiment, the texture units are configured to load texture maps (e.g., a 2D array of texels) from the memory 1612 and sample the texture maps to produce sampled texture values for use in shader programs executed by the streaming multiprocessor 1900. In an embodiment, the texture maps are stored in the shared memory/L1 cache 1918. The texture units implement texture operations such as filtering operations using mip-maps (e.g., texture maps of varying levels of detail). In an embodiment, each streaming multiprocessor 1900 includes two texture units.

Each streaming multiprocessor 1900 also comprises N load/store unit 1914 modules that implement load and store operations between the shared memory/L1 cache 1918 and the register file 1908. Each streaming multiprocessor 1900 includes an interconnect network 1916 that connects each of the functional units to the register file 1908 and the load/store unit 1914 to the register file 1908 and shared memory/L1 cache 1918. In an embodiment, the interconnect network 1916 is a crossbar that can be configured to connect any of the functional units to any of the registers in the register file 1908 and connect the load/store unit 1914 modules to the register file 1908 and memory locations in shared memory/L1 cache 1918.

The shared memory/L1 cache 1918 is an array of on-chip memory that allows for data storage and communication between the streaming multiprocessor 1900 and the primitive engine 1712 and between threads in the streaming multiprocessor 1900. In an embodiment, the shared memory/L1 cache 1918 comprises 128 KB of storage capacity and is in the path from the streaming multiprocessor 1900 to the memory partition unit 1800. The shared memory/L1 cache 1918 can be used to cache reads and writes. One or more of the shared memory/L1 cache 1918, level two cache 1804, and memory 1612 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 1918 enables the shared memory/L1 cache 1918 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 16, are bypassed, creating a much simpler programming model. In the general purpose parallel computation configuration, the work distribution unit 1610 assigns and distributes blocks of threads directly to the data processing cluster 1706 modules. The threads in a block execute the same program, using a unique thread ID in the calculation to ensure each thread generates unique results, using the streaming multiprocessor 1900 to execute the program and perform calculations, shared memory/L1 cache 1918 to communicate between threads, and the load/store unit 1914 to read and write global memory through the shared memory/L1 cache 1918 and the memory partition unit 1800. When configured for general purpose parallel computation, the streaming multiprocessor 1900 can also write commands that the scheduler unit 1608 can use to launch new work on the data processing cluster 1706 modules.

The parallel processing unit 2008b may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 2008b is embodied on a single semiconductor substrate. In another embodiment, the parallel processing unit 2008b is included in a system-on-a-chip (SoC) along with one or more other devices such as additional parallel processing unit 2008b modules, the memory 1612, a reduced instruction set computer (RISC) CPU, a memory management unit (MMU), a digital-to-analog converter (DAC), and the like.

In an embodiment, the parallel processing unit 2008b may be included on a graphics card that includes one or more memory devices. The graphics card may be configured to interface with a PCIe slot on a motherboard of a desktop computer. In yet another embodiment, the parallel processing unit 2008b may be an integrated graphics processing unit (iGPU) or parallel processor included in the chipset of the motherboard.

### Exemplary Computing System

Systems with multiple GPUs and CPUs are used in a variety of industries as developers expose and leverage parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 20 is a conceptual diagram of a processing system 2000 implemented using the parallel processing unit 2008b of FIG. 16, in accordance with an embodiment. The processing system 2000 includes a central processing unit 2006, switch 2004, and multiple parallel processing unit 2008b modules each and respective memory 1612 modules. The NVLink 1616 provides high-speed communication links between each of the parallel processing unit 2008b modules. Although a particular number of NVLink 1616 and interconnect 1618 connections are depicted in FIG. 20, the number of connections to each parallel processing unit 2008b and the central processing unit 2006 may vary. The switch 2004 interfaces between the interconnect 1618 and the central processing unit 2006. The parallel processing unit 2008b modules, memory 1612 modules, and NVLink 1616 connections may be situated on a single semiconductor platform to form a parallel processing module 2002. In an embodiment, the switch 2004 supports two or more protocols to interface between various different connections and/or links.

In another embodiment (not shown), the NVLink 1616 provides one or more high-speed communication links between each of the parallel processing unit modules (parallel processing unit 2008a, parallel processing unit 2008b, parallel processing unit 2008c . . . parallel processing unit 2008d) and the central processing unit 2006 and the switch 2004 interfaces between the interconnect 1618 and each of the parallel processing unit modules. The parallel processing unit modules, memory 1612 modules, and interconnect 1618 may be situated on a single semiconductor platform to form a parallel processing module 2002. In yet another embodiment (not shown), the interconnect 1618 provides one or more communication links between each of the parallel processing unit modules and the central processing unit 2006 and the switch 2004 interfaces between each of the parallel processing unit modules using the NVLink 1616 to provide one or more high-speed communication links between the parallel processing unit modules. In another embodiment (not shown), the NVLink 1616 provides one or more high-speed communication links between the parallel processing unit modules and the central processing unit 2006 through the switch 2004. In yet another embodiment (not shown), the interconnect 1618 provides one or more communication links between each of the parallel processing unit modules directly. One or more of the NVLink 1616 high-speed communication links may be implemented as a physical NVLink interconnect or either an on-chip or on-die interconnect using the same protocol as the NVLink 1616.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a traditional bus implementation. Of course, the various circuits or devices may also be situated separately or in various combinations of semiconductor platforms per the desires of the user. Alternately, the parallel processing module 2002 may be implemented as a circuit board substrate and each of the parallel processing unit modules and/or memory 1612 modules may be packaged devices. In an embodiment, the central processing unit 2006, switch 2004, and the parallel processing module 2002 are situated on a single semiconductor platform.

In an embodiment, the signaling rate of each NVLink 1616 is 20 to 25 Gigabits/second and each parallel processing unit module includes six NVLink 1616 interfaces (as shown in FIG. 20, five NVLink 1616 interfaces are included for each parallel processing unit module). Each NVLink 1616 provides a data transfer rate of 25 Gigabytes/second in each direction, with six links providing 300 Gigabytes/second. The NVLink 1616 can be used exclusively for PPU-to-PPU communication as shown in FIG. 20, or some combination of PPU-to-PPU and PPU-to-CPU, when the central processing unit 2006 also includes one or more NVLink 1616 interfaces.

In an embodiment, the NVLink 1616 allows direct load/store/atomic access from the central processing unit 2006 to each parallel processing unit module's memory 1612. In an embodiment, the NVLink 1616 supports coherency operations, allowing data read from the memory 1612 modules to be stored in the cache hierarchy of the central processing unit 2006, reducing cache access latency for the central processing unit 2006. In an embodiment, the NVLink 1616 includes support for Address Translation Services (ATS), enabling the parallel processing unit module to directly access page tables within the central processing unit 2006. One or more of the NVLink 1616 may also be configured to operate in a low-power mode.

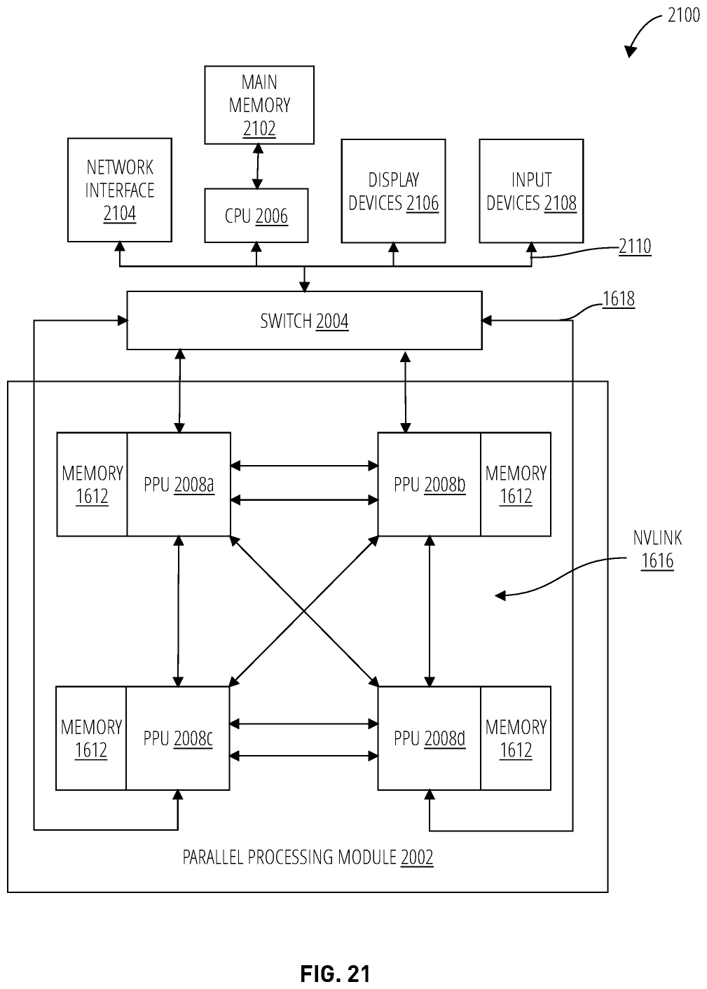

FIG. 21 depicts an exemplary processing system 2100 in which the various architecture and/or functionality of the various previous embodiments may be implemented. As shown, an exemplary processing system 2100 is provided including at least one central processing unit 2006 that is connected to a communications bus 2110. The communication communications bus 2110 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system 2100 also includes a main memory 2102. Control logic (software) and data are stored in the main memory 2102 which may take the form of random access memory (RAM).

The exemplary processing system 2100 also includes input devices 2108, the parallel processing module 2002, and display devices 2106, e.g. a CRT (cathode ray tube), LCD (liquid crystal display), LED (light emitting diode), plasma display or the like. User input may be received from the input devices 2108, e.g., keyboard, mouse, touchpad, microphone, and the like. Each of the foregoing modules and/or devices may even be situated on a single semiconductor platform to form the exemplary processing system 2100. Alternately, the various modules may also be situated separately or in various combinations of semiconductor platforms per the desires of the user.

Further, the exemplary processing system 2100 may be coupled to a network (e.g., a telecommunications network, local area network (LAN), wireless network, wide area network (WAN) such as the Internet, peer-to-peer network, cable network, or the like) through a network interface 2104 for communication purposes.

The exemplary processing system 2100 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 2102 and/or the secondary storage. Such computer programs, when executed, enable the exemplary processing system 2100 to perform various functions. The main memory 2102, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the exemplary processing system 2100 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of an embodiment should not be limited by any of the above-described exemplary embodiments, but should be defined in accordance with the following claims and their equivalents.

### Graphics Processing Pipeline

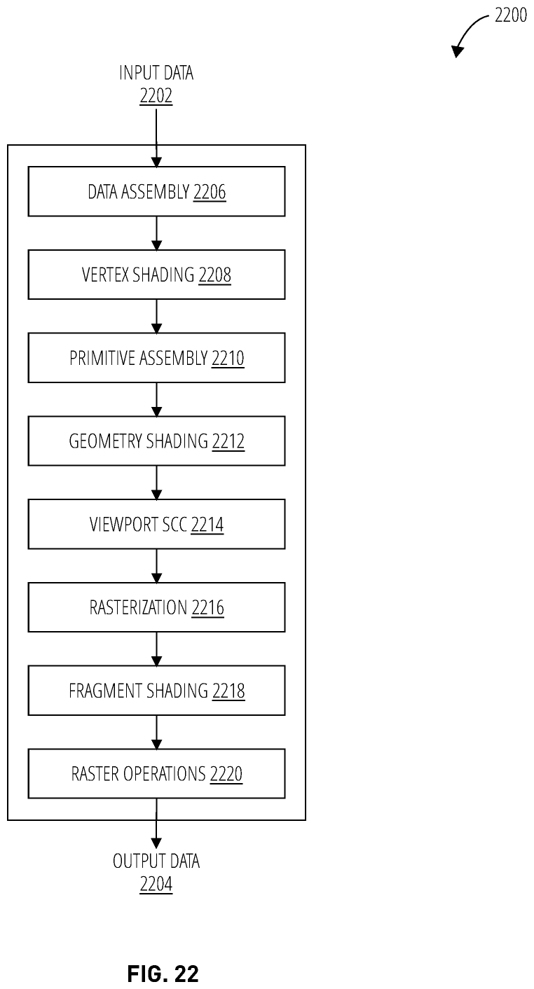

FIG. 22 is a conceptual diagram of a graphics processing pipeline 2200 implemented by the parallel processing unit 2008b of FIG. 16, in accordance with an embodiment. In an embodiment, the parallel processing unit 2008b comprises a graphics processing unit (GPU). The parallel processing unit 2008b is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The parallel processing unit 2008b can be configured to process the graphics primitives to generate a frame buffer (e.g., pixel data for each of the pixels of the display).

An application writes model data for a scene (e.g., a collection of vertices and attributes) to a memory such as a system memory or memory 1612. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the streaming multiprocessor 1900 modules of the parallel processing unit 2008b including one or more of a vertex shader, hull shader, domain shader, geometry shader, and a pixel shader. For example, one or more of the streaming multiprocessor 1900 modules may be configured to execute a vertex shader program that processes a number of vertices defined by the model data. In an embodiment, the different streaming multiprocessor 1900 modules may be configured to execute different shader programs concurrently. For example, a first subset of streaming multiprocessor 1900 modules may be configured to execute a vertex shader program while a second subset of streaming multiprocessor 1900 modules may be configured to execute a pixel shader program. The first subset of streaming multiprocessor 1900 modules processes vertex data to produce processed vertex data and writes the processed vertex data to the level two cache 1804 and/or the memory 1612. After the processed vertex data is rasterized (e.g., transformed from three-dimensional data into two-dimensional data in screen space) to produce fragment data, the second subset of streaming multiprocessor 1900 modules executes a pixel shader to produce processed fragment data, which is then blended with other processed fragment data and written to the frame buffer in memory 1612. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

The graphics processing pipeline 2200 is an abstract flow diagram of the processing steps implemented to generate 2D computer-generated images from 3D geometry data. As is well-known, pipeline architectures may perform long latency operations more efficiently by splitting up the operation into a plurality of stages, where the output of each stage is coupled to the input of the next successive stage. Thus, the graphics processing pipeline 2200 receives input data 601 that is transmitted from one stage to the next stage of the graphics processing pipeline 2200 to generate output data 2204. In an embodiment, the graphics processing pipeline 2200 may represent a graphics processing pipeline defined by the OpenGL® API. As an option, the graphics processing pipeline 2200 may be implemented in the context of the functionality and architecture of the previous Figures and/or any subsequent Figure(s).

As shown in FIG. 22, the graphics processing pipeline 2200 comprises a pipeline architecture that includes a number of stages. The stages include, but are not limited to, a data assembly 2206 stage, a vertex shading 2208 stage, a primitive assembly 2210 stage, a geometry shading 2212 stage, a viewport SCC 2214 stage, a rasterization 2216 stage, a fragment shading 2218 stage, and a raster operations 2220 stage. In an embodiment, the input data 2202 comprises commands that configure the processing units to implement the stages of the graphics processing pipeline 2200 and geometric primitives (e.g., points, lines, triangles, quads, triangle strips or fans, etc.) to be processed by the stages. The output data 2204 may comprise pixel data (e.g., color data) that is copied into a frame buffer or other type of surface data structure in a memory.

The data assembly 2206 stage receives the input data 2202 that specifies vertex data for high-order surfaces, primitives, or the like. The data assembly 2206 stage collects the vertex data in a temporary storage or queue, such as by receiving a command from the host processor that includes a pointer to a buffer in memory and reading the vertex data from the buffer. The vertex data is then transmitted to the vertex shading 2208 stage for processing.

The vertex shading 2208 stage processes vertex data by performing a set of operations (e.g., a vertex shader or a program) once for each of the vertices. Vertices may be, e.g., specified as a 4-coordinate vector (e.g., <x, y, z, w>) associated with one or more vertex attributes (e.g., color, texture coordinates, surface normal, etc.). The vertex shading 2208 stage may manipulate individual vertex attributes such as position, color, texture coordinates, and the like. In other words, the vertex shading 2208 stage performs operations on the vertex coordinates or other vertex attributes associated with a vertex. Such operations commonly including lighting operations (e.g., modifying color attributes for a vertex) and transformation operations (e.g., modifying the coordinate space for a vertex). For example, vertices may be specified using coordinates in an object-coordinate space, which are transformed by multiplying the coordinates by a matrix that translates the coordinates from the object-coordinate space into a world space or a normalized-device-coordinate (NCD) space. The vertex shading 2208 stage generates transformed vertex data that is transmitted to the primitive assembly 2210 stage.

The primitive assembly 2210 stage collects vertices output by the vertex shading 2208 stage and groups the vertices into geometric primitives for processing by the geometry shading 2212 stage. For example, the primitive assembly 2210 stage may be configured to group every three consecutive vertices as a geometric primitive (e.g., a triangle) for transmission to the geometry shading 2212 stage. In some embodiments, specific vertices may be reused for consecutive geometric primitives (e.g., two consecutive triangles in a triangle strip may share two vertices). The primitive assembly 2210 stage transmits geometric primitives (e.g., a collection of associated vertices) to the geometry shading 2212 stage.

The geometry shading 2212 stage processes geometric primitives by performing a set of operations (e.g., a geometry shader or program) on the geometric primitives. Tessellation operations may generate one or more geometric primitives from each geometric primitive. In other words, the geometry shading 2212 stage may subdivide each geometric primitive into a finer mesh of two or more geometric primitives for processing by the rest of the graphics processing pipeline 2200. The geometry shading 2212 stage transmits geometric primitives to the viewport SCC 2214 stage.

In an embodiment, the graphics processing pipeline 2200 may operate within a streaming multiprocessor and the vertex shading 2208 stage, the primitive assembly 2210 stage, the geometry shading 2212 stage, the fragment shading 2218 stage, and/or hardware/software associated therewith, may sequentially perform processing operations. Once the sequential processing operations are complete, in an embodiment, the viewport SCC 2214 stage may utilize the data. In an embodiment, primitive data processed by one or more of the stages in the graphics processing pipeline 2200 may be written to a cache (e.g. L1 cache, a vertex cache, etc.). In this case, in an embodiment, the viewport SCC 2214 stage may access the data in the cache. In an embodiment, the viewport SCC 2214 stage and the rasterization 2216 stage are implemented as fixed function circuitry.

The viewport SCC 2214 stage performs viewport scaling, culling, and clipping of the geometric primitives. Each surface being rendered to is associated with an abstract camera position. The camera position represents a location of a viewer looking at the scene and defines a viewing frustum that encloses the objects of the scene. The viewing frustum may include a viewing plane, a rear plane, and four clipping planes. Any geometric primitive outside of the viewing frustum may be culled (e.g., discarded) because the geometric primitive does not contribute to the final rendered scene. Any geometric primitive that is partially inside the viewing frustum and partially outside the viewing frustum may be clipped (e.g., transformed into a new geometric primitive that is enclosed within the viewing frustum. Furthermore, geometric primitives may each be scaled based on a depth of the viewing frustum. Potentially visible geometric primitives are then transmitted to the rasterization 2216 stage.

The rasterization 2216 stage converts the 3D geometric primitives into 2D fragments (e.g. capable of being utilized for display, etc.). The rasterization 2216 stage may be configured to utilize the vertices of the geometric primitives to setup a set of plane equations from which various attributes can be interpolated. The rasterization 2216 stage may also compute a coverage mask for a plurality of pixels that indicates whether one or more sample locations for the pixel intercept the geometric primitive. In an embodiment, z-testing may also be performed to determine if the geometric primitive is occluded by other geometric primitives that have already been rasterized. The rasterization 2216 stage generates fragment data (e.g., interpolated vertex attributes associated with a particular sample location for each covered pixel) that are transmitted to the fragment shading 2218 stage.

The fragment shading 2218 stage processes fragment data by performing a set of operations (e.g., a fragment shader or a program) on each of the fragments. The fragment shading 2218 stage may generate pixel data (e.g., color values) for the fragment such as by performing lighting operations or sampling texture maps using interpolated texture coordinates for the fragment. The fragment shading 2218 stage generates pixel data that is transmitted to the raster operations 2220 stage.

The raster operations 2220 stage may perform various operations on the pixel data such as performing alpha tests, stencil tests, and blending the pixel data with other pixel data corresponding to other fragments associated with the pixel. When the raster operations 2220 stage has finished processing the pixel data (e.g., the output data 2204), the pixel data may be written to a render target such as a frame buffer, a color buffer, or the like.

It may be appreciated that one or more additional stages may be included in the graphics processing pipeline 2200 in addition to or in lieu of one or more of the stages described above. Various implementations of the abstract graphics processing pipeline may implement different stages. Furthermore, one or more of the stages described above may be excluded from the graphics processing pipeline in some embodiments (such as the geometry shading 2212 stage). Other types of graphics processing pipelines are contemplated as being within the scope of the present disclosure. Furthermore, any of the stages of the graphics processing pipeline 2200 may be implemented by one or more dedicated hardware units within a graphics processor such as parallel processing unit 2008b. Other stages of the graphics processing pipeline 2200 may be implemented by programmable hardware units such as the streaming multiprocessor 1900 of the parallel processing unit 2008b.

The graphics processing pipeline 2200 may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the parallel processing unit 2008b. The API provides an abstraction for a programmer that lets a programmer utilize specialized graphics hardware, such as the parallel processing unit 2008b, to generate the graphical data without requiring the programmer to utilize the specific instruction set for the parallel processing unit 2008b. The application may include an API call that is routed to the device driver for the parallel processing unit 2008b. The device driver interprets the API call and performs various operations to respond to the API call. In some instances, the device driver may perform operations by executing instructions on the CPU. In other instances, the device driver may perform operations, at least in part, by launching operations on the parallel processing unit 2008b utilizing an input/output interface between the CPU and the parallel processing unit 2008b. In an embodiment, the device driver is configured to implement the graphics processing pipeline 2200 utilizing the hardware of the parallel processing unit 2008b.

Various programs may be executed within the parallel processing unit 2008b in order to implement the various stages of the graphics processing pipeline 2200. For example, the device driver may launch a kernel on the parallel processing unit 2008b to perform the vertex shading 2208 stage on one streaming multiprocessor 1900 (or multiple streaming multiprocessor 1900 modules). The device driver (or the initial kernel executed by the parallel processing unit 2008b) may also launch other kernels on the parallel processing unit 2008b to perform other stages of the graphics processing pipeline 2200, such as the geometry shading 2212 stage and the fragment shading 2218 stage. In addition, some of the stages of the graphics processing pipeline 2200 may be implemented on fixed unit hardware such as a rasterizer or a data assembler implemented within the parallel processing unit 2008b. It may be appreciated that results from one kernel may be processed by one or more intervening fixed function hardware units before being processed by a subsequent kernel on a streaming multiprocessor 1900.

### LISTING OF DRAWING ELEMENTS

100 system
102 person
104 cloud computer system
106 IoT device
108 local area network
110 microphone
112 wide area network
114 neural network
116 Softmax layer
118 digital device
202 deep learning system
204 computing system
206 vehicle
208 robot
302 transformer neural network
304 input sequence
306 encoder
308 encoder stack
310 encoder
312 encoder
314 decoder stack
316 decoder
318 decoder
320 decoder
322 output sequence
402 encoder
404 self-attention layer
406 feed forward neural network
502 decoder
504 encoder-decoder attention layer
506 self-attention layer
508 feed forward neural network
602 attention layer
604 matrix multiply
606 query vectors
608 key vectors
610 value vectors
612 scores vector
614 dot product
616 Softmax
618 multiply
620 vector summation
700 Softmax algorithm
800 Softmax computational logic
802 vector integer maximum unit
804 power-2 computation unit
806 reduction unit
808 max selector
810 max comparator
812 memory buffer
814 power sum buffer
816 power sum selector
818 right shifter
820 adder
822 linear piecewise computation unit
824 fixed-point fractional splitter
826 left shift
828 Unnormalized Softmax unit
830 Normalization unit
832 look-up table
834 max comparator
836 vector element adder
900 distributed computing system
902 router interface
904 processing element
906 controller
908 normalization unit
910 global global memory buffer
912 memory
1002 global buffer
1004 controller
1006 DRAM
1008 network-on-a-chip router
1010 FPGA
1012 multi-die package
1014 processing elements
1016 network-on-a-package router
1018 dice
1020 host
1100 neural network processor
1200 processing element
1202 vector multiply-accumulate units
1204 weight buffer
1206 activation buffer
1208 router
1210 accumulation memory buffer
1212 post-processor
1214 controller
1300 processing element
1302 input weights
1304 input activations
1306 partial sums
1308 cross-processing-element reductions
1310 weight memory buffer manager
1312 activation memory buffer manager
1314 address generator
1316 accumulation memory buffer manager
1318 address generator
1320 weight collector
1322 accumulation collector
1324 vector multiply accumulate unit
1326 output activations
1328 input collector
1502 global memory buffer
1504 controller
1506 activation address generator
1508 data path
1510 destination address generator
1512 register file
1514 output activations
1516 partial sums
1518 input activations
1520 arbitrated memory banks
1522 global processing element
1602 I/O unit
1604 front-end unit
1606 hub
1608 scheduler unit
1610 work distribution unit
1612 memory
1614 crossbar
1616 NVLink
1618 interconnect
1700 general processing cluster
1702 pipeline manager
1704 pre-raster operations unit
1706 data processing cluster
1708 raster engine
1710 M-pipe controller
1712 primitive engine
1714 work distribution crossbar
1716 memory management unit
1800 memory partition unit
1802 raster operations unit
1804 level two cache
1806 memory interface
1900 streaming multiprocessor
1902 instruction cache
1904 scheduler unit
1906 dispatch
1908 register file
1910 core
1912 special function unit
1914 load/store unit
1916 interconnect network
1918 shared memory/L1 cache
2000 processing system
2002 parallel processing module
2004 switch
2006 central processing unit
2008a parallel processing unit
2008b parallel processing unit
2008c parallel processing unit
2008d parallel processing unit
2100 exemplary processing system
2102 main memory
2104 network interface
2106 display devices
2108 input devices
2110 communications bus
2200 graphics processing pipeline
2202 input data
2204 output data
2206 data assembly
2208 vertex shading
2210 primitive assembly
2212 geometry shading
2214 viewport SCC
2216 rasterization
2218 fragment shading
2220 raster operations

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, logical registers 0 and 1 specifically.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the claimed subject matter may also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it may be apparent that modifications and variations are possible without departing from the scope of the disclosure as claimed. The scope of disclosed subject matter is not limited to the depicted embodiments but is rather set forth in the following Claims.

What is claimed is:

1. A system comprising:
one or more processors; and
logic that when applied to the one or more processors computes an unnormalized Softmax vector from an input vector by:
raising elements of the input vector to powers of two;
computing an integer vector maximum of the input vector; and
logic that when applied to the one or more processors transforms the unnormalized Softmax vector into a normalized Softmax vector.

2. The system of claim 1, further comprising:
the one or more processors comprising a plurality of processing elements; and
logic to configure the plurality of processing elements to compute the unnormalized Softmax vector in a distributed computation.

3. The system of claim 2, further comprising logic to:
configure at least some of the plurality of processing elements to compute local integer maximums of their respective input vectors; and
configure at least some of the plurality of processing elements to perform cross-processing-element reduction of the local integer maximums to a global integer maximum.

4. The system of claim 2, further comprising logic to:
configure the one or more processors to compute a sum of the powers of two.

5. The system of claim 4, further comprising logic to:
configure at least some of the plurality of processing elements to compute local sums of the powers of two for their respective input vectors; and
configure at least some of the plurality of processing elements to perform cross-processing-element reduction of the local sums of the powers of two to a global sum of the powers of two.

6. The system of claim 2, further comprising:
a central normalizing unit to transform the unnormalized Softmax vector into the normalized Softmax vector.

7. The system of claim 1, wherein the logic to compute the unnormalized Softmax vector further configures the one or more processors to:
raise the elements of the input vector to the powers of two and compute the integer vector maximum in a single execution loop.

8. The system of claim 7, wherein the logic to compute an unnormalized Softmax vector further configures the one or more processors to:
compute a sum of the powers of two in the single execution loop.

9. An artificial neural network comprising:
one or more feed-forward layers; and
one or more Softmax layers coupled to the one or more feed-forward layers;
at least one of the Softmax layers configured to compute an unnormalized Softmax vector from an input vector by:
raising elements of the input vector to powers of two; and
computing an integer vector maximum of the input vector.

10. The artificial neural network of claim 9, the at least one Softmax layer further configured to:
transform the unnormalized Softmax vector into a normalized Softmax vector.

11. The artificial neural network of claim 10, the at least one Softmax layer further configured to:
transform the unnormalized Softmax vector into a normalized Softmax vector utilizing shift and reciprocal operations without performing multiplication operations.

12. The artificial neural network of claim 9, the at least one Softmax layer further configured to:
utilize a plurality of processing elements to compute the unnormalized Softmax vector in a distributed computation.

13. The artificial neural network of claim 12, the at least one Softmax layer further configured to:
utilize at least some of the plurality of processing elements to compute local integer maximums of their respective input vectors; and
utilize at least some of the plurality of processing elements to perform cross-processing-element reduction of the local integer maximums to a global integer maximum.

14. The artificial neural network of claim 12, the at least one Softmax layer further configured to compute a sum of the powers of two.

15. The artificial neural network of claim 14, the at least one Softmax layer further configured to:
utilize at least some of the plurality of processing elements to compute local sums of the powers of two for their respective input vectors; and
utilize at least some of the plurality of processing elements to perform cross-processing-element reduction of the local sums of the powers of two to a global sum of the powers of two.

16. The artificial neural network of claim 12, the at least one Softmax layer further configured to:
transform the unnormalized Softmax vector into a normalized Softmax vector.

17. The artificial neural network of claim 9, the at least one Softmax layer further configured to:
raise the elements of the input vector to the powers of two and compute the integer vector maximum in a single execution loop.

18. The artificial neural network of claim 17, the at least one Softmax layer further configured to:
compute a sum of the powers of two in the single execution loop.

19. A transformer artificial neural network comprising:
a self-attention layer; and
an encoder-decoder attention layer;
each of the self-attention layer and the encoder-decoder attention layer comprising a Softmax layer configured to generate an unnormalized Softmax vector from an input vector by:
raising elements of the input vector to powers of two; and
computing an integer vector maximum of the input vector.

20. The transformer artificial neural network of claim 19, each Softmax layer further configured to:
generate the unnormalized Softmax vector by raising the elements of the input vector to the powers of two, compute the integer vector maximum, and calculate a sum of the powers of two in a single execution loop; and
transform the unnormalized Softmax vector into a normalized Softmax vector utilizing shift and reciprocal operations without performing multiplication operations.

21. A non-transitory computer-readable storage medium, the computer-readable storage medium including instructions that when executed by a computer, cause the computer to perform neural network inference by:
formulating a vector of 2^{x} valued elements in a Softmax computation, where each x is an element of an input vector to the Softmax computation; and
computing an integer maximum value of x in the input vector.

22. The non-transitory computer-readable storage medium of claim 21, the computer-readable storage medium further including instructions that when executed by the computer, cause the computer to:
generate an unnormalized Softmax vector from the vector of 2^{x} elements and the integer maximum value.

23. The non-transitory computer-readable storage medium of claim 22, the computer-readable storage medium further including instructions that when executed by the computer, cause the computer to:
normalize the unnormalized Softmax vector.

24. The non-transitory computer-readable storage medium of claim 21, the computer-readable storage medium further including instructions that when executed by the computer, cause the computer to:
formulate the vector of 2^{x} elements in a Softmax computation, compute the integer maximum value of x in the input vector, and calculate a sum of the vector of 2^{x} elements in a single execution loop.

25. A method executed in an artificial neural network layer, the method comprising:
executing first machine instructions to formulate a vector of 2^{x} valued elements in a Softmax computation, where each x is an element of an input vector to the Softmax computation; and
executing second instructions to compute an integer maximum value of x in the input vector.
